(19) United States
(12) Patent Application Publication
(10) Pub. No.: US 2026/0090938 A1
(43) Pub. Date: Apr. 2, 2026

(54) FRICTION-LIFT TORSO HARNESS AND PATIENT HANDLING DEVICE

(71) Applicant: Hapai Transfer Systems Limited, Middleton, Christchurch (NZ)

(72) Inventor: Alexander Nicholas O'Keefe, Sydenham, Christchurch (NZ)

(21) Appl. No.: 19/126,789

(22) PCT Filed: Nov. 2, 2023
(86) PCT No.: PCT/NZ2023/050121

§ 371 Date: May 2, 2025

(30) Foreign Application Priority Data
Nov. 2, 2022 (NZ) 794042

(51) Int. Cl. A61G 7/10

(52) U.S. Cl. CPC A61G 7/1051; A61G 7/1015; A61G 7/1046; A61G 7/1086

(57) ABSTRACT

A friction-lift torso harness for lifting patients with a patient lift hoist. The friction-lift torso harness includes a tensioning mechanism. A harness band is coupled to the tensioning mechanism and the friction-lift torso harness is configured to apply a compressive force to the patient's torso above the patient's hips during raising of a patient wearing the friction-lift torso harness. The compressive force applied by the tensioning mechanism is proportional to the patient's weight such that a patient can be lifted solely through frictional contact with the harness band without use of leg straps or the like.

### CROSS REFERENCE TO RELATED APPLICATIONS

This present application is a a § 371 national stage of International Application PCT/NZ2023/050121, filed Nov. 2, 2023, which claims priority benefit of New Zealand Pat. Application Ser. No. 794042, filed Nov. 2, 2022, both of which are hereby incorporated herein by reference in their entireties.

### FIELD OF THE DISCLOSURE

The present disclosure relates to apparatus and methods for patient handling. In particular, the present disclosure relates to patient handling, using a friction-lift torso harness and patient handling device. The patient handling including raising and lowering a seated patient between seated and raised activity positions.

### BACKGROUND

The movement of persons having limited mobility presents a challenge. Often elderly, sick, or physically impaired individuals lack the strength to lift themselves from a seated position into a traditional transport aid such as a walking frame or a wheelchair for transport to another location. Lifting these individuals to assist their transfer can be awkward and may require a level of strength that a caregiver is unable to provide physically or according to safety guidelines.

While existing devices have been used to assist with transferring persons of limited mobility from a seated position, many are complex, expensive, difficult to use and/or place many patients in awkward or uncomfortable positions during use. In addition, these devices typically have a large footprint and are heavy, making them impractical for many applications, particularly for use in the home.

It is also manifestly desirable to minimise any discomfort experienced by the person being transferred due to the motion and/or ergonomics of the device. U.S. Pat. No. 8,832,874 by Alexander describes various embodiments of a person moving device for moving patients of limited mobility. Although effective in lifting and moving patients, the Alexander embodiments were found to be uncomfortable for certain patients during the raising and lowering processes.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

### SUMMARY

Numerous situations and circumstances exist whereby an at least partially incapacitated, injured or infirmed person (hereinafter referred to as a ‘patient’) in some measure requires assistance in being raised from a seated position to a raised activity position, e.g. a standing or movement position. In particular, the need to be moved safely and comfortably between sitting positions is synonymous with the ubiquitous daily human needs for toileting, washing, clothing changes and the like. A patient handling device is disclosed that is capable of raising and lowering a patient between seated and raised positions, where the device provides improved comfort, reduced cost or complexity.

It is an object of at least preferred embodiments of the present disclosure to address one or more of the above-mentioned disadvantages and/or to at least provide the public with a useful alternative. The disclosed embodiments are particularly, though not exclusively, suited to assisting such a patient together with at least one other person, hereinafter referred to as a ‘carer’. It will be appreciated that healthy individuals may also desire or require assistance with being raised or lowered and as such, may utilise the disclosed embodiments.

The present disclosure relates, in part, to a person-moving device, hereinafter referred to as a ‘patient moving device’.

It should be understood the terms patient and carer are not limiting and include, respectively, any person requiring movement assistance and any person assisting with the movement and are not limited, respectively, to formally/officially designated patients or health-care professional.

Thus, as used herein, the term ‘patient’ also includes any person using the disclosed embodiments, irrespective of their physical heath or mobility status.

As used herein, the term ‘chassis’ includes any rolling chassis or any other mobile or static structure, platform, housing, framework, body, monocoque, or movable carriage and track, or other load-bearing configuration.

As used herein, the term ‘terrain’, includes the earth's surface or any surface overlaying same including, but not limited to, flooring, carpet, roadways, footpaths, lifts and the like.

As used herein, the terms ‘person raising, lifting, lowering, moving, transporting, or relocating’ and/or ‘patient moving, raising, lifting, lowering, moving, transporting, or relocating’ should be understood to be encompassed by the terms ‘patient (or person) moving’, and ‘patient (or person) handling’, unless explicitly stated to the contrary.

To aid brevity, the term ‘lifting’ will be used to refer interchangeably to both the lifting and converse ‘lowering’ of the person unless explicitly stated to the contrary.

As used herein, the term ‘encircling, and ‘encirclement’ with respect to a torso, includes any configuration of an object passing fully about the torso periphery, excluding limbs, and is not restricted to circular, curved, regular, irregular or any other configuration, and includes object portions both in intimate contact with, and portions separate from the torso surface.

As used herein, the term ‘activity position’ includes a patient raised to any position between a seated position and fully upright. Activities in the activity position, include, but are not limited to transportation, standing, stretching, repositioning, transfer between seating positions, toileting, bathing, medical and/or nursing treatment and the like.

As used herein, the term ‘sitting, or seated’, includes the position of a patient with an appreciable proportion of their weight being supported by a surface underneath their gluteal region, irrespective of the nature of the surface, the position of the patient's torso and whether the patient also has one or both legs also supporting any portion of the patient's weight; and any position where the patient's torso and/or Centre of Mass (CoM) is in a vertically lower position than in a raised activity position.

As used herein, the terms ‘lift hoist’, and ‘patient lift hoist’ include any mechanism able to reversibly raise and lower a patient, including a patient wearing a friction-lift torso harness. The terms ‘lift hoist’, and ‘patient lift hoist’ include any mechanism which includes any mechanical, electrical, pneumatic and/or hydraulic drive and/or control means or the like and any combination of same, including fully manually operated lift hoists, power-assisted lift hoists and fully powered lift hoists able to raise and lower the weight of a patient without any human motive assistance.

As used herein, the term ‘strand’, ‘lift strand’ and ‘tensioning strand’ includes any length, wire, fibre, filament, cord, cable, ligament or the like, and is not restricted to any particular method of construction, degree of rigidity or flexibility.

As used herein, the term ‘pulley’ includes an at least partially curved surface for engagement with a strand and which acts to change the direction of, and/or transmit a force applied to the strand, wherein the curved surface may be fixed, movable and/or rotatable, and includes surfaces of constant and non-constant radius.

As used herein, the term ‘pulley system’ includes any system including at least one pulley as defined herein.

As used herein, the term ‘sheave’ is defined as a fixed, or non-rotatable pulley with an at least partially curved surface for engagement with a strand and which acts to change the direction of, and/or transmit a force applied to the strand and includes curved surfaces of constant and non-constant radius.

As used herein, the term ‘spreader bar’ includes any structure, element, material or the like and any portion of same, configured as an interface to spread a tension applied at one or more points of the spreader bar, over a larger area, or region via the spreader bar.

As used herein, a patient's ‘exterior torso’ is defined to include both the external surface of the skin about the patient's torso and any layers of clothing, or other garments worn by the patient about the torso during patient handling. It will be appreciated there may be occasional need for patient handling of a partially or fully unclothed patient. Although the disclosed embodiments may still be successfully used for patient handling in such situations, the overwhelming majority of use cases involve patients with at least one clothing layer about their torso. Thus, to aid clarity and readability and unless otherwise stated, references to the patient and the patient's torso will be understood to include the presence of one or more clothing layers about the torso unless explicitly stated to the contrary. This does not indicate the disclosed embodiments are in any way restricted to same.

A desirable interaction between the patient and carer through the use of a patient moving device is a balance of ensuring the patient's physical comfort and safety, whilst efficiently utilising the physical input of the carer without requiring difficult, strenuous or complex inputs.

In a commonplace, exemplary situation in a nursing care facility/assisted living-type environment, an elderly and/or infirmed patient seated in a chair may be unable to raise themselves from the chair unassisted. Similarly, further assistance may be required to transport them to, and be safely lowered onto, the toilet, together with appropriate clothing and sanitary assistance and then reversing the procedure to be returned to their chair.

As used herein the term ‘moving’ should be understood to refer to any repositioning or reorientation and includes any linear or rotational movement and any combination of the aforementioned.

It should also be explicitly noted, that as used herein, the terms “patient-moving device” and a “friction-lift torso harness” also includes such a device configured for use in a fixed or static position, (either temporarily or permanently), and includes lifting a seated person or patient to undertake any desired or required activities before being subsequently lowered into the same seating position.

Carers such as family, friends and even trained health care professionals are vulnerable to musculoskeletal injuries during patient handling activities. This injury risk is exacerbated if available lifting equipment is complex, slow/difficult to implement and/or otherwise places additional time-pressure on busy staff.

Protecting the carers from injury during patient handling, whilst ensuring effective patient handling may require the efficient application of the carer's physical strength via simple, controllable, safely constrained movements.

Fully-electrically-powered lifting devices remove any direct need for a carer to provide the motive lifting force. However, the motive electrical power is traditionally supplied either by potentially cumbersome cabling and/or stored in heavy battery storage, thus adding complexity and reduced device availability associated with device re-charging. In contrast, a fully mechanical, or electro-mechanical (mechanical with electric power assistance) device offers simplicity of operation, immediate availability and high reliability. It can thus be seen that fully electrically powered, electro-mechanical and fully mechanical lifting devices all offer characteristics that may suited to different environments and use-cases.

According to a first aspect of the present disclosure, there is provided a friction-lift torso harness for patient handling, the patient handling including raising and lowering a seated patient between a seated position and a raised activity position by lifting the friction-lift torso harness with a patient lift hoist, the friction-lift torso harness including a tensioning mechanism,
wherein, the friction-lift torso harness is configured to apply a compressive force to the patient's torso between at least two opposing exterior torso portions, during at least part of the raising of a patient wearing the friction-lift torso harness,
characterised in that the compressive force is proportional to the patient's weight being contemporaneously applied to the patient lift hoist.

According to a second aspect of the present disclosure, there is provided a patient-moving device for patient handling, the patient handling including raising and lowering a seated patient between a seated position and a raised activity position, the device including:
a friction-lift torso harness including a tensioning mechanism, the friction-lift torso harness configured to apply a compressive force to the patient's torso between at least two opposing exterior torso portions,
a patient lift hoist,
at least one tensioning strand, operatively connected between the tensioning mechanism and the lift hoist,
characterised in that for at least part of raising a patient, the compressive force is proportional to the patient's weight being contemporaneously applied to the patient lift hoist via the at least one tensioning strand.

According to another aspect of the present disclosure there is provided a friction-lift torso harness for patient handling, the patient handling including raising and lowering a seated patient between a seated position and a raised activity position by lifting the friction-lift torso harness with a patient lift hoist, the friction-lift torso harness including:
a tensioning mechanism including at least one tensioning strand, and
one or more torso-engagement sections coupled to the tensioning mechanism,
wherein, during at least part of the raising of a patient wearing the friction-lift torso harness, the friction-lift torso harness is configured to apply a compressive force, above the patient's hips and to the patient's torso, between at least two opposing exterior torso portions,
wherein the compressive force is applied with the tensioning mechanism via the one or more torso-engagement sections, and
characterised in that the tensioning mechanism includes a pulley system with at least one rotatable pulley, the at least one tensioning strand passing about the at least one rotatable pulley, and
wherein the compressive force applied by the tensioning mechanism is proportional to the patient's weight being contemporaneously applied to the patient lift hoist.

Optionally, the compressive force is applied above the patient's hips to the exterior torso portions of the patient including at least portions between the patient's 5th and 10th ribs.

Optionally, the compressive force is applied substantially orthogonally to the exterior torso portions.

Optionally, the compressive force is applied above the patient's hips solely to the exterior torso portions. Thus, according to one embodiment, no compressive force is applied during lifting through any partial or complete encirclement of any of the patient's limbs by the friction-lift torso harness.

It will be appreciated that patient handling implicitly requires the avoidance of subjecting patients to unnecessary discomfort, such as those generated by excessive accelerations or decelerations. Moreover, slow lifting and lowering speeds enable opportunity for constant evaluation of, and consultation with, the patient by the carer. Thus, the lift/lowering acceleration employed during patient handling is also low, with a maximum generally in the order of 0.1 ms⁻² and typically around 0.07 ms⁻². An acceleration of 0.1 ms⁻² imparts a force less than 1% than due gravity, and thus is negligible in terms of patient handling. This lift/lowering force is therefore excluded from the following analysis unless stated explicitly to the contrary.

According to another aspect of the present disclosure, there is provided a method of operating a patient-moving device, the patient moving device including:
a friction-lift torso harness including a tensioning mechanism, the friction-lift torso harness configured to apply a compressive force above the patient's hips to the patient's torso between at least two opposing exterior torso portions,
a patient lift hoist,
at least one tensioning strand,
wherein the method for patient handling including raising and lowering a seated patient between a seated position and a raised activity position includes the steps of:
fitting the friction-lift torso harness to a sitting patient above the patient's hips and about the patient's exterior torso;
ensuring at least one tensioning strand is operatively connected between the friction-lift torso harness tensioning mechanism and the lift hoist;
operating the patient lift hoist to raise the at least one tensioning strand;
applying a compressive force to the patient's torso between the at least two opposing exterior torso portions, the compressive force being proportional to the patient's weight being contemporaneously applied to the patient lift hoist via the at least one tensioning strand.

Optionally, the method further includes;
after fitting the friction-lift torso harness to a sitting patient above the patient's hips and about the patient's exterior torso, manually tensioning the friction-lift torso harness to a pre-tension level sufficient to maintain self-supported contact with the torso, but below a threshold value to successfully lift the patient.

The tensioning strand may be formed as a continuous strand or from multiple separate individual strands.

Thus, with the friction-lift torso harness tensioned by the carer sufficient for it to remain in position, but without excessive compression, the patient can remain comfortably in the seated position. If lifting is then cancelled for any reason or delayed for any of the myriad reasons that may arise in nursing/care facilities or domestically, wearing the friction-lift torso harness will not further exacerbate the situation nor cause undue discomfort.

The ability to raise and lower a patient without the patient-disruption of fitting leg, groin or thigh straps or being manoeuvred to pass a sling or harness underneath their gluteal region offers tangible patient-comfort benefits. Using the friction-lift torso harness above the patient's hips to obviate the necessity to use any limb straps to raise a patient confers further advantages after being fitted to a seated patient, namely:
the fitted friction-lift torso harness need only be initially tightened by a carer to a relatively low level whilst the patient is still seated;
only once lifting commences does the compressive force applied to the patient start to increase. If lifting is delayed or postponed for any reason, the patient does not need to endure any extended discomfort from wearing a highly pre-tensioned harness.
at any instant during lifting, the compressive force applied is proportional to the patient's weight being supported by the friction-lift torso harness at that instant. Thus, the progressive rate of increasing compression during lifting is continuously controllable and, if necessary or desired, reversible, by the carer operating the lift hoist. Throughout any lifting or lowering the carer is able to receive continuous visual and auditory patient feedback and consultation regarding the patient's status and comfort and adjust the rate or direction of the lift hoist accordingly.
allowing any patient able to bear their weight at least partially on their legs, to be allowed to do so during the lifting.
allowing the compressive force exerted by the friction-lift torso harness to be reduced once the patient reaches an upright activity position, as the proportion of the patient's weight supported by the friction-lift torso harness is commensurately reduced as an increased proportion is supported by the patient's legs. This enhances the ability for the patient to remain standing for extended periods without maintaining a high compressive force about the torso.
the absence of any strength, mobility, or balance threshold or any other patient requirements or inputs needed for the patient to be successfully and safely raised or lowered. The patient may remain completely passive throughout patient handling without hindering successful operation of the patient moving device and/or friction-lift torso harness.
the friction-lift torso harness is configured to dynamically adapt to the particular shape and nature of the patient's torso during use, thereby minimising the potential for uneven and/or uncomfortable distribution of the compressive force.

Optionally, the patient-moving device further includes a chassis.

In one embodiment, the chassis is a terrain-engaging mobile chassis. Alternatively, the chassis may include at least one carriage, movably coupled to a track, optionally mounted on an elevated structure, ceiling, gantry, terrain-engaging mobile chassis or the like.

Optionally, the patient handling includes moving, and/or transporting a patient in the activity position.

Optionally, the friction-lift torso harness is configured such that the compressive force is proportional to the patient's weight being contemporaneously applied to the patient lift hoist via the at least one tensioning strand throughout the process of raising the patient.

Optionally, the tensioning mechanism is configured to, in use, reversibly vary tension in the friction-lift torso harness during patient raising or lowering.

Optionally, the tensioning mechanism increases or reduces the friction-lift torso harness tension in use by respectively decreasing and increasing the circumference of the friction-lift torso harness about the patient's exterior torso.

In general terms, the friction-lift torso harness grips the patient by applying a compressive force to the torso. The compressive force is, at least initially, achieved by reducing the inner circumference of the friction-lift torso harness contacting the torso. This reduction in the friction-lift torso harness inner circumference is caused by increasing the tension applied to the friction-lift torso harness.

The effect of this compressive force is to initially compresses the patient's clothing and soft flesh until an equilibrium point is reached where the compressive force is equal to the reaction force generated by the compressed torso. Thereafter, increasing the tension in the friction-lift torso harness will still increase the compressive force applied to the torso, but without appreciably reducing the inner circumference of the friction-lift torso harness as the reaction force will accordingly increase with the compressive force.

The friction force between the friction-lift torso harness and torso increases as the compressive force increases, and thus a lift force can be applied to lift the friction-lift torso harness and patient therein.

The lift force is translated via the tensioning mechanism to simultaneously apply the compressive force to the patient. As the friction-lift torso harness is only engaged about the torso of the patient, this upwards lift force only acts on the patient via the frictional force generated between the friction-lift torso harness and torso, in contrast to prior art devices that apply a lift force to limbs, gluteus, ribs, underarms or other body parts.

A portion of the patient will be lifted by the hoist only if the:
a) lift force exceeds the weight of the portion of the patient to be lifted, and
b) friction force between the patient's torso and the friction-lift torso harness equals or exceeds the weight of the portion of the patient to be lifted.

Thus, if the friction force is too low, the friction-lift torso harness will simply slide up the patient's torso. If the lift force is too low, the patient will remain stationary.

Moreover, the magnitude of the compressive force on the torso at any instant is directly proportional to the weight of the portion of the patient being lifted at that instant. Thus, as a greater proportion of the patient's weight is lifted as they gradually rise from being seated, the compressive force on the torso gradually increases at the same progressive rate.

Optionally, the friction-lift torso harness is capable of lifting at least 50%, (such as at least 70%) of a patient's weight during the patient raising, solely by frictional force applied between the friction-lift torso harness and the patients' torso, the frictional force being generated in reaction to the compressive force.

In a further embodiment, the friction-lift torso harness is capable of lifting 100% of a patient's weight during the patient raising, solely by frictional force applied between the friction-lift torso harness and the patients' torso, the frictional force being generated in reaction to the compressive force.

As discussed elsewhere, once fitted to the patient, the friction-lift torso harness may be pre-tensioned about the patient's torso with minimal force, thereby avoiding initially subjecting the patient to an uncomfortably high level of compressive force. In contrast, attempting to use a harness that requires ‘pre-tensioning’ to provide the entirety, majority or indeed even any significant portion of the total compressive force required, may lead to an intolerable level of discomfort for most patients and is therefore impractical, hence requiring use of limb straps or the like to provide most of the lifting force.

In contrast, in the present disclosure, as the compressive force applied to the torso of the patient only increases proportionally to the contemporaneous weight of the patient being lifted via the friction-lift torso harness, there is no requirement for excessive pre-tension to be applied to the patient while the patient is seated, and their weight is already being supported.

Optionally, the friction-lift torso harness is configured for pre-tensioning via a releasable fastening, wherein in use, when fitted to a patient, the releasable fastening is capable of applying a pre-tension to the patient via the friction-lift torso harness, the pre-tension corresponding to a proportion of the patient's weight to be lifted, where 100% pre-tension corresponds to a maximum value of the tension required to grip the lifted portion of the patient.

Optionally, the friction-lift torso harness is configured to only apply a pre-tension of less than 50% of the tension required to grip the lifted portion of the patient during the patient raising, the friction-lift torso harness applying the remainder of the tension required e.g. for a pre-tension value of 50%, the friction-lift torso harness applies the remaining 50% required.

In a further embodiment, the friction-lift torso harness is configured to only apply a pre-tension of less than 30% (such as less than 20%) of the tension required to grip the lifted portion of the patient.

The above parameters may also be restated in terms of the compressive force applied to the patient by the pre-tension, rather than the total tension in the friction-lift torso harness required to grip the lifted portion of the patient. Thus, optionally, the friction-lift torso harness is configured for pre-tensioning via a releasable fastening, wherein in use, when fitted to a patient, the releasable fastening is capable of applying a pre-tension to the patient via the friction-lift torso harness, the pre-tension corresponding to a proportion of the maximum compressive force required to lift the patient's weight, where 100% pre-tension corresponds to a maximum value of the compressive force required to lift the patient.

Optionally, the releasable fastening is capable of applying a pre-tension of less than 50% of the compressive force required to lift the lifted portion of the patient's weight during the patient raising, the friction-lift torso harness applying the remainder of the compressive force required, e.g. for a pre-tension value of 50%, the friction-lift torso harness applies the remaining 50% compressive force required.

In a further embodiment, the releasable fastening is capable of applying a pre-tension of less than 30% (such as less than 20%) of the compressive force required to lift the patient's lifted weight.

In contrast to prior art systems, the friction-lift torso harness will successfully lift the patient with only a degree of pre-tensioning necessary to support the friction-lift torso harness in position about the patient's torso. The pre-tension does not need to contribute to the total tension needed to achieve a successful lift.

Thus, according to a further aspect, the friction-lift torso harness is configured with a pre-tension of between 10-40%, (such as 10-20%) and thereafter lifting at least 50%, (such as at least 70%) of a patient's weight during the patient raising, solely by frictional force applied between the friction-lift torso harness and the patients' torso, the frictional force being generated in reaction to the tension creating a compressive force.

Optionally, the friction-lift torso harness, further includes one or more torso-engagement sections, coupled to the tensioning mechanism.

Optionally, the torso-engagement sections are at least partially rigid, semi-rigid, flexible, elastic, inelastic and/or any combination of same.

Optionally, the friction-lift torso harness, includes at least two the torso-engagement sections.

It will thus be appreciated that the torso engagement sections may take many forms, provided that in conjunction with the tensioning mechanism, in use the torso-engagement sections permit at least one of:
the friction-lift torso harness to be fitted to a patient to form an encirclement about a patient's exterior torso;
the tensioning mechanism to apply a variable tension in the friction-lift torso harness during patient raising or lowering;
at least partly encircling a patient's torso between a patient's 5^{th} and 10th ribs.

Optionally, the torso-engagement section is configured to further include:
size-adjustment means (e.g., straps, clips, springs, slides, etc), and/or
the releasable fastening, optionally including one or more closure and/or securement means, such as zips, buttons, toggles, studs, buckles, straps, pins, hooks and the like.

The torso-engagement section may, for example, take the form of a flexible fabric band, or vest, able to be wrapped about the patient's torso, and tensioned during use via the tensioning mechanism during lifting and lowering. It will also be apparent that numerous different forms of torso-engagement sections are possible without departing from the scope of the present disclosure.

Optionally, the torso-engagement sections are formed as a harness band. As used herein, the term ‘band’ does not imply any particular shape or configuration, uniformity, elongation, or other property or constraints other than being able to at least partially encircle a patient's torso.

As used herein, the term ‘harness’ also does not imply any specific configurations or properties, other than being able to at least partially encircle a patient's torso and does not imply any portion or element of the harness is fitted to, or surrounds, or partially surrounds, a patient's shoulder, or axilla.

In one embodiment the harness band may be formed by a pair of the torso-engagement sections connectable together via a pair of separate connections, in the form of the releasable fastening, and the tensioning mechanism, respectively.

Optionally, the tensioning mechanism includes at least one spreader set.

Optionally, the spreader set includes at least two spreader bars.

As reiterated previously, the term ‘spreader bar’ as used herein includes any structure, element, material or the like and any portion of same, configured as an interface to spread a tension applied at one or more points of the spreader bar, over a larger area, or region via the spreader bar. Thus, while a spreader bar may be readily conceived, eponymously, as a distinct elongate bar, the term also covers other, non-elongate shapes and a region or portion of a surface, object, or material with sufficient rigidity to able to disperse, or transmit an applied force over a wider/larger region or area than the area or region of the input force/tension. Consequently, in considering the function of a spreader bar being used as an interface to apply tension from the tension mechanism to the harness band, a spreader bar may alternatively be:
a distinct element, attached to a portion of the harness band, or
formed as a rigid, semi-rigid, sufficiently stiffened portion, or an integrated part of, the harness band itself.

Thus, in the latter case, according to one aspect, the harness band includes at least one spreader bar at a distal end.

Optionally, the harness band includes two spreader bars, located at two corresponding opposing distal ends of the harness band.

Optionally, the spreader set includes a pair of mutually opposed spreader bars, at least one of the spreader bars being reversibly movable towards, and away from, the other spreader bar of the pair.

Optionally, the spreader set includes a pair of spreader bars, each with a substantially elongate axis, orientated mutually parallel to, and reversibly movable towards and away from, the other spreader bar of the pair.

Optionally, when fitted to a patient, the harness band, and attached tensioning mechanism, collectively form the encirclement about the patient's exterior torso.

Optionally, the tensioning mechanism is attached between separate portions of the torso-engagement sections, such as formed as the harness band.

Optionally, the friction-lift torso harness includes a bridge panel member.

Optionally, the bridge panel member is attached between separate portions of the torso-engagement sections, optionally between portions of the harness band.

Optionally, the bridge panel member is attached;
between separate portions of the harness band, and
to the tensioning mechanism.

A bridge panel member may serve multiple functions, including;
preventing the tensioning mechanism becoming entangled with, or injuring, the patient by positioning of the bridge panel member between the tensioning mechanism and the patient's torso; and
providing a mounting point for one or more spreader bars.

Optionally, the tensioning mechanism includes at least one pulley system, through which the tensioning strand may pass.

Optionally, the pulley system includes at least one pulley mounted on, or operatively connected to the torso-engagement sections.

Optionally, the pulley system includes at least one pulley mounted on, or operatively connected to a spreader bar.

Optionally, the pulley system includes at least one pulley mounted on, or operatively connected to the bridge panel member.

It can thus be appreciated that permutations of pulley mounting positions are possible in configuring a tensioning mechanism including a pulley system.

As referenced above, the term ‘pulley’, as used herein, includes an at least partially curved surface for engagement with a strand and which acts to change the direction of, and/or transmit a force applied to the strand, wherein the curved surface may be fixed, movable and/or rotatable, and includes surfaces of constant and non-constant radius. A further fundamental characteristic of a pulley (and thus, a pulley system) is that they operated by pulling, not pushing. Thus, it is incumbent for a successful pulley system configuration, that the positioning of the pulley allows the tension in the tensioning strand to be able to reversibly reduce the circumference of the friction-lift torso harness, by reversibly pulling, (i.e., reversibly applying a tension to) the harness band.

Axiomatically, a pulley mounted on a bridge panel member cannot be operatively connected to another portion of the same bridge panel member.

Thus, according to one aspect, a pulley mounted on a:
harness band, at a first position,
first spreader bar, or
bridge panel member,
   may be operatively connected to one of the:
harness band, at a second position, or
a second spreader bar.

Optionally, the first and second harness band positions are, respectively, first and second distal ends, with the tensioning mechanism attached therebetween.

Optionally, the tensioning mechanism includes at least one spreader set with at least two spreader bars.

However, it can be seen that the above definition of a spreader bar also encompasses a bridge panel member. Thus, according to one aspect, a friction-lift torso harness includes a spreader set with at least two spreader bars, at least one spreader bar being formed as:
an elongate bar, attached to a portion of the harness band, or
a rigid, semi-rigid, or stiffened portion of the harness band, or
a portion of a bridge panel member.

Optionally, the friction-lift torso harness includes two or more spreader sets.

Optionally, the harness band includes a pair of spreader sets configured to be positioned, in use, on substantially opposing portions of the torso.

Alternatively, the substantially opposing portions of the torso may be located:
anteriorly and posteriorly, or
laterally.

It will be understood by one skilled in the art that numerous friction-lift torso harness configurations are encompassed by the present disclosure, including differing types and numbers of:
spreader sets;
spreader bars;
types of spreader bars;
pulley numbers;
types and locations of:
   pulley systems;
   bridge panel members;
   harness band; and
permutations and combination of same.

However, the successful lifting of a patient is also dependant on a sufficiently effective holding of the patient to prevent any sliding between the friction-lift torso harness and the patient's torso. Not only is it largely impractical, it is also highly undesirable to simply apply an excessive compressive force to the patient's torso to ensure sufficient friction for a successful lift. The desirable goal, from the standpoint of both ensuring patient comfort and of effective execution of patient handling prioritises the following characteristics during a friction-lift torso harness lift, namely:
applying the minimum necessary compression force to the torso for a successful and safe lift;
maximising the ratio of tension applied to the harness band from the tensioning mechanism, from that received by the tensioning mechanism from the lift strand, i.e., minimizing tension losses, particularly in the tensioning mechanism;
continuously and responsively adjusting the harness band tension during lifting and lowering whilst complying with the above objectives.

The interrelationship between the force of the lifted weight of the patient (represented by F_{w}) and the tension applied to the harness band (represented by T_{B}) represents a critical relationship for determining the successful ability to lift a patient.

Experimental investigation and research have established the ability of this relationship to determine a threshold value of a factor necessary for achieving a successful patient lift using a torso-type harness. The relationship T_{B}/F_{w} is defined as a ‘Proportional Forcing Factor (PFF), denoted by k_{pff}. The derivation and further exploration of the underpinning calculations are explored in later sections.

However, in summary, it can be shown that for a given lifted weight force, F_{w}, and a tension T_{B} (assumed constant in this case) applied to the harness band, a Proportional Forcing Factor (PFF), k_{pff} is given by:

$${k}_{pff} = \frac{{T}_{B}}{{F}_{w}}$$

Substituting and rearranging gives the PFF (k_{PFF}) in terms of the relationship between F_{w}, and T_{B}, for a given coefficient of friction, μ_{eff}, gives:

$${k}_{pff} = \frac{1}{( 2 π {f}_{band} {μ}_{eff} )}$$

where μ_{eff}, is the effective coefficient of friction of the clothed torso of a given patient.

In use, the tension T_{B} applied to the harness band between the spreader bars will pass over the surface of the patient torso with an associated friction causing a consequential reduction in the harness band tension designated by f_{band}, as explored further elsewhere.

Thus, for a given coefficient of friction, μ_{eff}, a PFF greater than a predetermined lift-threshold PFF may be required to ensure the weight being lifted by the friction-lift torso harness will not slip.

It has also been established through experimental research that in this application, the effective coefficient of friction μ_{eff} for a patient is between about 0.4-0.5.

Thus, using the median value of μ_{eff}=0.45 and f_{band}=0.8 for a tensioning mechanism with a single spreader set gives the result;

$$\frac{1}{( 2 π 0.45 0.8 )} = 0.44$$

Thus, for a compressive friction-lift torso harness to lift a patient's torso solely by its effective frictional force with the torso and without lift force from any limb straps, the PFF value governing how the force due to the lifted weight is converted into tension about the torso typically needs a value of k_{PFF} of at least 0.4. However, a PFF of 0.4 is a minimal value and may not be sufficient in some circumstances, e.g. where patient's clothing has very low friction. Thus, preferred embodiments will have a higher PFF, ideally with a PFF of at least 0.5.

A PFF value of ≥0.4 is not achievable by existing prior art lifting and/or patient handling devices using the general principle of using a person's body weight to tighten some form of a vest or torso band. Such existing devices are thus only used to stabilise, but not lift a patient, or used in conjunction with other means to achieve patient lifting, i.e., leg straps, groin straps, axilla slings knee pads and the like.

Achieving, or exceeding a PFF value of ≥0.4 is thus challenging, and may require engineering and ergonomic efficiency and refinement, embodied in a friction-lift torso harness with:
an efficient tension mechanism,
an optimally positioned harness band about the patient's torso allowing compressive force to be applied at least between the patient's 5^{th} and 10^{th} ribs,
minimal tension losses,
while ensuring the compressive force is proportional to the patient's weight being contemporaneously applied to the patient lift hoist via the at least one tensioning strand.

The PFF, i.e., the interrelationship between the force of the lifted weight of the patient F_{w} and the tension applied to the harness band T_{B} may also be expressed in different terms, namely the mechanical advantage (MA) and frictional efficiency (fₜₘ). The relationship between these terms is given as:

$$P F F = M A \times {f}_{tm}$$

Where the Mechanical Advantage (MA) of the tensioning mechanism is determined by observing or calculating the magnitude by which it converts the lifted weight into band tension—if no losses in the system are considered.

The efficiency at which the tensioning mechanism transfers the lifted weight into band tension is given as a single term fₜₘ for the purpose of this explanation, representing the total frictional efficiency of the system in percent, i.e., 100% minus all frictional losses.

It can be thus seen that optimising either, and optionally both the mechanical advantage (MA) and frictional efficiency (fₜₘ) of the tensioning mechanism (12) is key to the PFF generated. It has been determined that in order to be capable of generating a PFF of 0.4, it is necessary for the tensioning mechanism to be configured with a Mechanical Advantage (MA) of at least 0.5 and/or a system with an fₜₘ of at least 50%.

Moreover, the efficiency of the tensioning mechanism (irrespective of its configuration) is significantly impacted by the efficiency of the re-direction of the vertically orientated tension in the tension strands (between the lift hooks and the tension mechanism) to a substantially horizontal orientation in the tension mechanism, i.e., a re-direction of substantially 90°.

Optionally, through an initial, substantially orthogonal, angular redirection of the tensioning strand in the tensioning mechanism, the:
Mechanical Advantage (MA) is at least 0.5, and/or
frictional efficiency (fₜₘ) of the tensioned tensioning strand is at least 50%.

It is desirable for a pulley to impart the least tension loss to the tensioning strand as it passes about its contact surface. Tension losses may largely arise due to:
surface friction between the strand exterior and the pulley surface,
rotational friction, from the bearings or axel of rotatable pulleys,
deformation of any portion of the pulley system under load.

Rotatable pulleys offer significantly higher efficiencies comparative to fixed pulleys (also referred to herein as sheaves) and are relatively inexpensive, widely available, and robust. Pulleys with low friction bearings, such as ball bearings, roller bearings and the like offer even higher efficiencies.

Optionally, the at least one pulley is configured with:
a rotatable fixed-radius circular surface,
a rotatable non-constant radius circular surface, or
two or more rotatable co-axial circular surfaces of non-equal radii.

Numerous tensioning mechanism configurations with differing forms of pulley systems may be chosen according to the specific needs and functionality desired. Pulley systems with one, two, or more pulleys, multiple pulley pairs configured in a cross-lacing configuration, efficient pulleys with low-friction bearings, different mounting arrangements and spreader bar configurations and the like are described in greater detail herein.

Optionally, the friction-lift torso harness includes a spreader set configured with two spreader bars, mounted to allow mutually independent orientation. Thus, in use the spreader bars are also able to assume a mutually non-parallel configuration e.g., to form a V, or inverted V-shape. Thus, the friction-lift torso harness is capable of accommodating variations in torso shapes, allowing the combined harness band and tensioning mechanism to match not only the shape of the patient, (who may, for example, have a proportionally larger upper torso, or lower thorax/abdomen) but also accommodate differences in the manner that separate regions of the torso react to compression.

Alternative tensioning mechanisms include, but are not limited to;
electronically controlled actuators, control electronics and weight sensors, determining the instantaneous weight being support by the friction-lift torso harness, wherein the control electronics receives data of the instantaneous weight measured from the weight sensors and outputs control signals to the actuators to apply a tension to the friction-lift torso harness, proportional to the instantaneous weight data, or
an inflatable girdle, control electronics and weight sensors, determining the instantaneous weight being support by the friction-lift torso harness, wherein the control electronics receives data of the instantaneous weight measured from the weight sensors and outputs control signals to the inflatable girdle to apply a tension to the friction-lift torso harness, by inflating or delating the girdle proportional to the instantaneous weight data.

A further beneficial characteristic of the friction-lift torso harness and patient handling device, in contrast to the prior art, is the ability to perform patient lifting and lowering without need to apply any external constraints or forces on the patient.

Lifting an adult human directly vertically, by sole means of a strap or sling under the axilla regions places a significant strain on the shoulders and is generally uncomfortable. Hence, such harness configurations are largely being confined to use in urgent circumstances (e.g., helicopter rescue via a use of lowered sling/strop) and are unsuited to use in patient-care environments, with their attendant high volumes of patient lifting and aversion to causing unnecessary patient discomfort.

Instead, prior art sit-to-stand hoists rely on additional supports to assist lifting the patient, including;
knee braces, to act as a fulcrum to pivot the patient's torso (and upper legs) as the axilla strap pulls them upwards and forwards upwards, and/or
leg straps, groin straps, and/or slings passing beneath the patient's gluteal region.

Unfortunately, using knee braces in this manner can place an uncomfortable degree of pressure on the patient's knees. Groin straps and/or thigh leg straps do provide the capacity to lift a patient, though this comes at the expense of comfort, freedom of leg movement and ease of fitment.

Notwithstanding further recognised performance-related drawbacks to using both knee braces or leg straps, both techniques do not allow the patient to be raised vertically, without also being horizontally impeded, constrained or otherwise subject to an impetus during lifting. In contrast, the friction-lift torso harness and patient handling device allow the patient to be lifted with their Centre of Mass (CoM) position to be suspended beneath the effective lift point, thus obviating the need for any external horizontal forces.

It is often desirable however for the patient to be lifted upwards and slightly forwards to allow clearance once in the standing position from an immovable seat. Such a lift trajectory may be accomplished by appropriate configuration of the lift hoist travel. The weight of an upright-seated patient, with their legs resting on the terrain surface is distributed between the surface of the seat surface below the torso and the terrain surface beneath the feet. It will be understood from a consideration of the kinematics involved, that the CoM of the patient will be positioned over the seat surface and thereafter move anteriorly as their torso raises and moves horizontally toward their knees until becoming centred over their feet once standing. If the horizontal path of the lift hoist substantially mirrors the horizontal travel of the patient's CoM, it will be appreciated that, in combination with the upward vertical travel, the dynamics of the combined movement also mirror the natural human dynamics during a typical, unassisted standing form seated movement. Moreover, in the final portion of travel at the full extent of the lifting as the patient becomes fully upright, the patient's CoM will be brought into coincidence with the patient's footprint ensuring maximum stability.

If the patient is to remain standing for any appreciable duration, they may be partially supported by insertion of a support surface posteriorly across their gluteal region. Additionally, knee pads may be used in such applications to provide additional bracing for the patient. It will thus be noted that the bracing function of the knee pads for a raised patient, is in no way comparable to the above-described prior art techniques used to raise a patient.

Optionally, the friction-lift torso harness incorporates a respiration relief mechanism.

Optionally, the respiration relief mechanism incorporates an elastomeric or resilient portion, configured with a spring bias vector opposing expansion of the friction-lift torso harness inner perimeter, with a spring force magnitude less than a chest expansion capacity of a respirating patient. Optionally, the respiration relief mechanism includes;
one or more springs, orientated in line with the applied tension in the harness band,
one or more elastic or resilient material sections of the harness band,
resilient or elastomeric padding, lining an inner surface of the harness band.

Optionally, the tension mechanism is releasably detachable from the friction-lift torso harness.

Optionally, the tension mechanism is releasably attached to the friction-lift torso harness by zipper fastening, pin and loop fastening, mechanical fasteners or the like.

It will be appreciated that the patient lift hoist of the patient-moving device may be adapted to replace (or supplement) the need for manual operation of the patient lift hoist by a carer, by incorporation of powered components, controlled by:
electronic operating controls, operable by a carer or patient during patient handling;
remote operation controls, operable by a career, or
autonomous controls, at least partially operable by a computer independently of direct carer or patient control.

It will further be appreciated that the specific means of operating the patient-moving device does not affect the advantageous features and beneficial patient-handling capabilities described herein. Consequently, to aid clarity and avoid prolixity and unless otherwise stated, the patient-moving device is described with respect to being manually operable by a carer during patient handling operation. This does not indicate the disclosed embodiments are in any way restricted to same.

Reference herein is made to various aspects and embodiments of the present disclosure. For clarity and to aid prolixity every possible combination, iteration or permutation of features, aspects and embodiments are not described explicitly. Thus, it should be appreciated that the disclosure herein includes any combination, iteration, multiple or permutation unless explicitly and specifically excluded.

The order in which aspects, embodiments, features or descriptions occur in this description should not be interpreted to necessarily require the preceding aspects, embodiments, features or descriptions.

Reference throughout this specification to the singular should be interpreted to include the plural and vice versa unless specifically stated otherwise.

These and other objects, advantages, purposes and features of the present disclosure will become apparent upon review of the following specification in conjunction with the drawings.

### BRIEF DESCRIPTION OF DRAWINGS

Further aspects and advantages of the present disclosure will become apparent from the following description which is given by way of example only and with reference to the accompanying drawings in which:

FIGS. 1a and 1b show a patient-moving device and a friction-lift torso harness according to one embodiment of the present disclosure;

FIG. 2 shows a frontal view of the friction-lift torso harness of FIG. 1, fitted to a patient;

FIG. 3 shows an enlarged rear view of the friction-lift torso harness of FIGS. 1 and 2;

FIGS. 4a and 4b show the friction-lift torso harness of FIG. 3, illustrating the effect of movement by lift wires;

FIGS. 5a and 5b show a simplified schematic of the forces involved in deriving how a tensioned encircling band lifts an object via friction force;

FIG. 6 shows a schematic diagram of the tension in a tensioned band as the band is pulled over the surface of an object;

FIGS. 7a-7d depict visual representations of different ellipsoids illustrating analysis of the nature of compressive forces being applied to a patient's torso;

FIGS. 8a-8c illustrate differing distributions of a lifting force applied to the friction-lift torso harness of FIGS. 1-4;

FIGS. 9a-9d show schematic representations of pulley lacing pattern variations that may be used in a tensioning mechanism in the friction-lift torso harness;

FIG. 10 shows an individual lacing step with a three-step lacing pattern;

FIGS. 11a and 11b show schematic diagrams of the friction-lift torso harness illustrating differing proportional forcing factors necessary to achieve a successful lift threshold PFF value;

FIG. 12 shows an alternative embodiment of a friction-lift torso;

FIGS. 13a and 13b respectively show another embodiment of a friction-lift torso harness and a schematic force analysis of the harness of 13a;

FIG. 14 shows another alternative embodiment of a friction-lift torso harness;

FIGS. 15a and 15b show a comparison of two embodiments of friction-lift torso harnesses with different tensioning mechanisms;

FIGS. 16a-16d show the friction-lift torso harness of FIG. 15b;

FIG. 17 shows the anterior skeletal structure and exterior surface of a human torso;

FIGS. 18a-18c show embodiments utilising an individual lift point comprised of a single lift hook;

FIGS. 19a-19b show an alternative embodiment of a friction-lift torso harness utilising four lift wires;

FIGS. 20a-20f show an alternative embodiment of a friction-lift torso harness, using only two lift wires;

FIG. 21 shows an embodiment of a friction-lift torso harness utilising an alternative configuration of tensioning mechanism than the single radius pulleys used in the preceding embodiments;

FIG. 22a-22c show alternative embodiments of a friction-lift torso harness;

FIG. 23a-23b show an alternative embodiment of a friction-lift torso harness using a ‘sandwich board’ configuration;

FIG. 24 shows an alternative embodiment of a friction-lift torso harness, with a respiration relief mechanism;

FIGS. 25a-25d show an alternative embodiment of a friction-lift torso harness, with a detachable tensioning mechanism shown in various stages of operation and detachment;

FIGS. 26a-26c show another alternative embodiment of a friction-lift torso harness, with a detachable tensioning mechanism having zips;

FIG. 27 shows another alternative embodiment of a friction-lift torso harness, with a detachable tensioning mechanism including pin and loop connectors;

FIGS. 28a and 28b respectively show other alternative embodiments of a friction-lift torso harness, with varying lifting hook positions; and

FIG. 29 shows a further embodiment of a friction-lift torso harness, employing a centre pulley.

### DETAILED DESCRIPTION

Although specific advantages have been enumerated above, various embodiments may include some, none, or all of the enumerated advantages. Other technical advantages may become readily apparent to one of ordinary skill in the art after review of the following figures and description.

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Unless otherwise specifically noted, articles depicted in the drawings are not necessarily drawn to scale.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

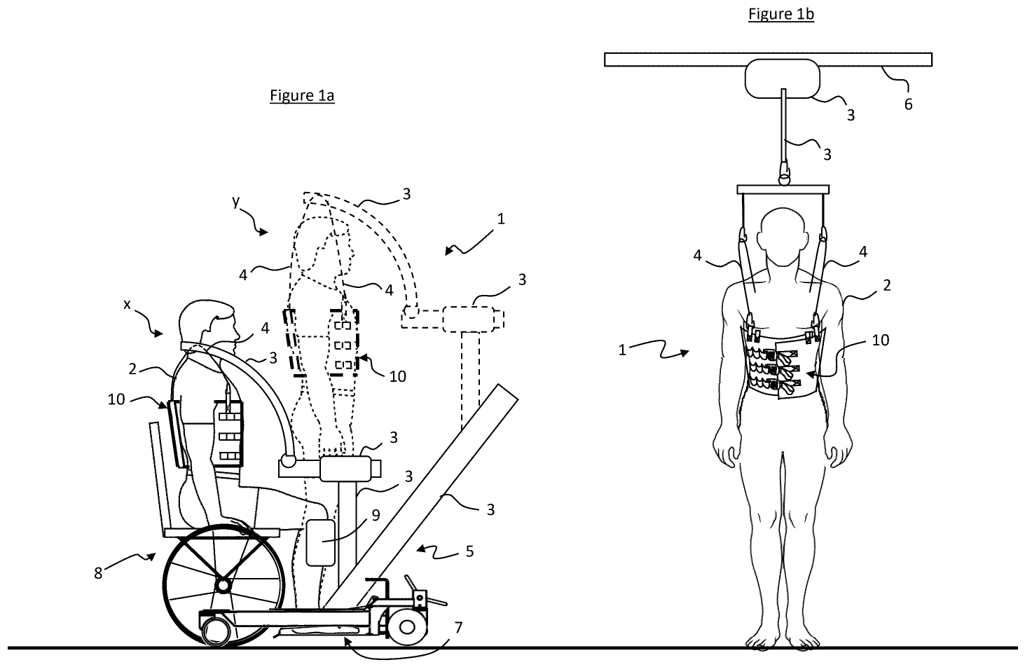

FIGS. 1a and 1b show preferred embodiments of the present disclosure in the form of a patient-moving device (1) and a friction-lift torso harness (10). It will be appreciated that the two embodiments, as shown in FIGS. 1a) and 1b) are exemplary only and not an exhaustive list as the disclosed embodiments (1, 10) may be used in a range of applications where the weight of a person needs supporting entirely or partially. As referenced previously, the term “patient” as used herein, also includes any person using the disclosed embodiments, for any purpose, irrespective of their physical heath or mobility status.

The patient-moving device (1) (also known as a ‘sit-to-stand’ device) is configured for patient handling, including raising and lowering a seated patient (2) between a seated position X and a raised activity position Y (shown in phantom in FIG. 1a).

The patient-moving device (1) further includes a patient lift hoist (3) and two tensioning strands, in the form of a pair of lift-wires (4), attached between the friction-lift torso harness (10) and the patient lift hoist (3). The patient (2) seated in wheelchair (8) in FIG. 1a) may be raised to the activity position Y for a variety of purposes, including rehabilitation/muscle strengthening, wellbeing, exercise, transport or repositioning to a new location, toileting, nursing care and so forth.

Prior art sit-to-stand hoists rely on the ability of the patient to lean back into a strap that is used to pull them to a standing position. However, if the patient is unable to exhibit, or maintain the strength to lean back during the transfer, they are at risk of falling. Thus, such hoists also rely on additional supports such as;
knee braces, to act as a pivot for the patient's torso as the strap around the patient's back and under their armpits raises them upwards, or
leg straps, groin straps, and/or slings passing beneath the patient's gluteal region. However, these are often uncomfortable during use and awkward to fit for seated patients with restricted mobility and/or strength.

The disclosed embodiment provides a more secure grip on the patient, thereby obviating any need for strength to participate in the transfer.

The patient-moving device (1) (shown in FIG. 1a)), incorporates a purpose-built mobile chassis (5) attached to the lift hoist (3) and is also provided with patient footplates (7) and knee braces (9).

Alternatively, the friction-lift torso harness (10) may be adapted to operate with an existing apparatus (not shown explicitly), such as a patient lift hoist (3), with associated lift wires (4), and supported by an existing chassis (5) or gantry (6).

In FIG. 1b), the patient (2) is already fully elevated in a standing position, supported beneath a gantry (6) by the friction-lift torso harness (10) suspended by the lift wires (4). Such a patient-moving device configuration allows for patient-supported standing, gait and balance training and rehabilitation.

Prior art walking harnesses/vests/slings are utilised in rehabilitation settings where a patient (2) is prescribed walking exercises as therapy but are at risk of falling during the exercise. Such existing vests are intended for use with a person who has some standing strength. Moreover, these vests always include groin or leg straps that would support a person's full weight in the event of a patient (2) collapse. The band/vest section around the torso may provide a small amount of lift force as it is tightened into the torso but is predominantly used for stabilising the patient from falling while walking or if being suspended via the groin straps.

The torso vest section is typically first tightened on the patient and then adjusted as the patient moves from a sitting to standing position, as the patient's body shape changes. The groin straps are often uncomfortable and can be hard to fit to a sitting person. In contrast, the disclosed friction-lift torso harness (10) allows easy fitment to a sitting person, without the need for groin straps.

Initial fitment of the friction-lift torso harness (10) may only require a comparatively low initial tension about the patient's torso, hence improving comfort. Moreover, the friction-lift torso harness (10) also may not require any subsequent external intervention (e.g. by medical staff or carer), as the torso tension is adjusted automatically throughout use, including patient handling and gait training.

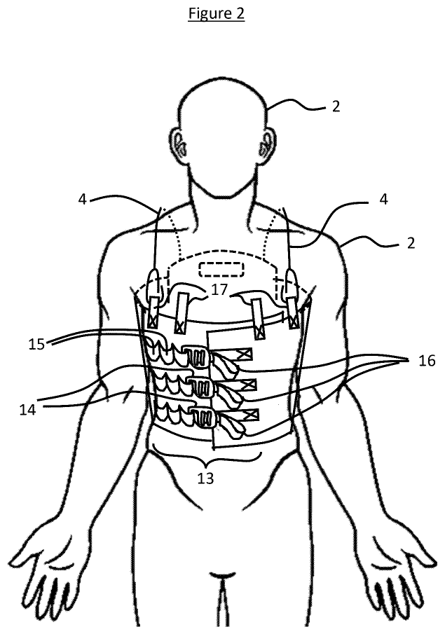

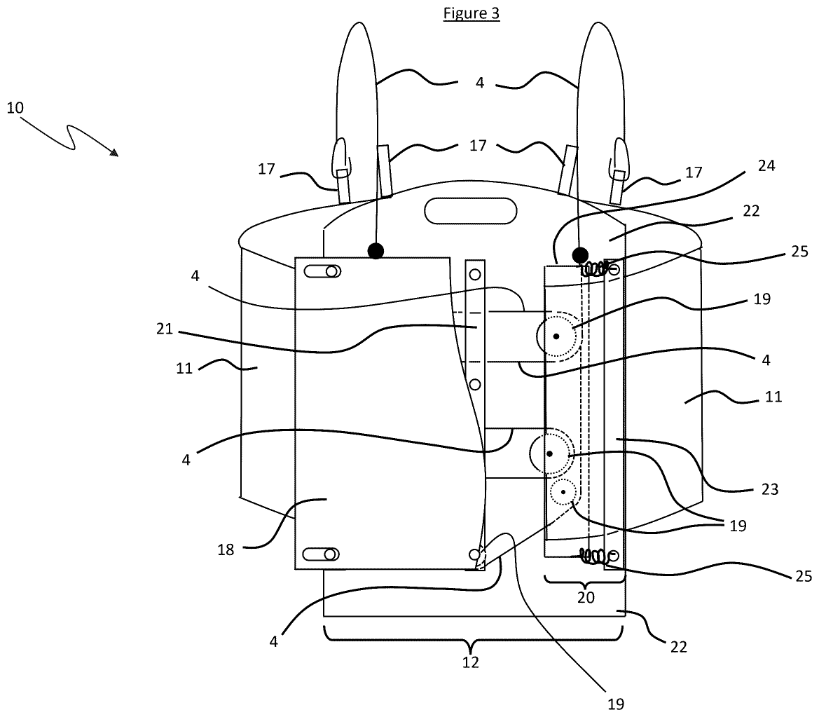

FIG. 2 shows a frontal view of the general arrangement of the friction-lift torso harness (10) fitted to a patient (2), while FIG. 3 shows an enlarged rear view of the friction-lift torso harness (10), with partial-cutaway for illustrative purposes.

The friction-lift torso harness (10) is formed to include torso-engagement sections, in the form of a harness band (11) of flexible fabric (e.g., ballistic nylon or the like), separated into two main portions, coupled together at two distal ends by a tensioning mechanism (12). A variety of existing tensioning mechanisms may be used and fall within the scope of the present disclosure. However, in preferred embodiments, pulley systems are utilised. Pulley systems offer many desirable characteristics for lightweight, simple, reliable, mechanical advantage mechanisms. Particularly advantageous pulley configurations are described subsequently in greater detail, though each configuration involves the use of at least one lift wire (4) passing about at least one pulley (19) to reversibly adjust the tension in the friction-lift torso harness (10) via the tensioning mechanism (12).

The friction-lift torso harness (10) is fitted by being wrapped about a patient's (2) exterior torso surface with the tensioning mechanism (12) positioned posteriorly. Anteriorly, a releasable fastening (13) in the form of hooks (14) and loops (15) enable the harness band (11) to be comfortably fitted and secured with minimal manipulation of, or discomfort for the patient (2)—e.g. without needing to raise the patient's arms, lift the torso (and/or leg) to fit lifting straps, and/or lean the patient's torso forwards or backwards to engage with a sling.

Multiple loops (15), arrayed across one side of the harness band (11) provide positional flexibility for the engagement of the corresponding hooks (14) to accommodate the size and fit of different patients (2). It will be readily evident that numerous other releasable fastener types may also be alternatively employed to achieve the same ends.

An adjustment mechanism is provided, in the form of adjustment straps (16) to allow the carer (not shown) to perform initial tightness/fit adjustment for the patient (2) of the friction-lift torso harness (10).

Lift tabs (17) are positioned anteriorly at the upper periphery of the harness band (11), allowing the distal ends of the pair of lift wires (4) to be releasably attached thereto. In the embodiments shown in FIGS. 1-4, the other ends of the pair of lift wires (4) are configured such that in use they pass over and above the patient's (2) shoulders to engage with other elements of the tensioning mechanism (12), as described in greater detail elsewhere.

Advantageously, and in contrast to prior art systems, the friction-lift torso harness (10) can be fitted securely to a seated patient (2) (via appropriate adjustment of the releasable fastening (13) and adjustment straps (16)) without initially subjecting the patient (2) to an uncomfortably high level of compressive force. In preferred embodiments, after the initial fitting and adjustment of the friction-lift torso harness (10) to the patient (2), the compressive force applied to the torso of the patient (2) only increases proportionally to the contemporaneous weight of the patient being lifted via the friction-lift torso harness (10). Thus, while the patient (2) is seated and their weight is being predominantly supported by the upper seat surface, there may be no requirement for excessive compression to be applied to the patient (2) by the friction-lift torso harness (10).

In overview, FIG. 3 shows the posterior view of the friction-lift torso harness (10), with protective cover (18), (show in partial cut-away) covering the outward-facing aspect of the tensioning mechanism (12) and adjacent harness band (11).

The tensioning mechanism (12) includes a pulley system with pulleys (19), mounted on a pair of harness spreader bars (20) (only one visible in FIG. 3) that are located at distal ends of the harness band (11). The pulley system also includes a lower pulley (19a) attached to a centre spreader bar (21).

A bridge panel member in the form of back board (22) is positioned between the tensioning mechanism (12) and the patient's posterior torso and serves to prevent elements of the tensioning mechanism (12) becoming entangled with, or injuring, the patient (2). The back board (22) also provides a mounting point for the centre spreader bar (21).

The lift wires (4) are attached to the lift tabs (17) on the front of the friction-lift torso harness (10). The lift wires (4) pass over the patient's (2) shoulders before interacting with the tensioning mechanism (12), passing about the pulleys (19) on the spreader bars (20, 21). It may also be seen in FIG. 3, that this preferred embodiment includes spreader bars (20) with additional functionality over that provided by a simple fixed rigid bar. The harness spreader bars (20) shown in FIG. 3 are each configured with a harness anchor bar (23), attached to the harness band (11) and to a corresponding pulley mounting bar (24). The pulley mounting bars (24) are elastically coupled to the corresponding harness anchor bar (23), by coupling springs (25). Consequently, both the pulley mounting bars (24) are able to independently displace from the harness anchor bars (23), allowing the pulley mounting bars (24) to splay apart according to the specific shape of the patient's torso and the comparative tension between different portions of the two harness anchor bars (23).

In a simplified embodiment (not shown), the spreader bars (20) may be formed as a single bar element combining both the harness anchor bar (23) and the pulley mounting bar (24), such that the pulleys (19) are attached to a spreader bar that is in turn attached directly to the harness band (11). Whilst such a configuration would be simpler, it offers limitations in terms of effectively conforming to the specific shape of individual patients (2). In alternative embodiments (not shown), at least one spreader bar (20) may be formed as an integral portion of the harness band (11) itself. Such configurations of an integrated spreader bar (20) may, for example, utilise strengthened, stiffened or otherwise reinforced portions of largely fabric harness bands (11).

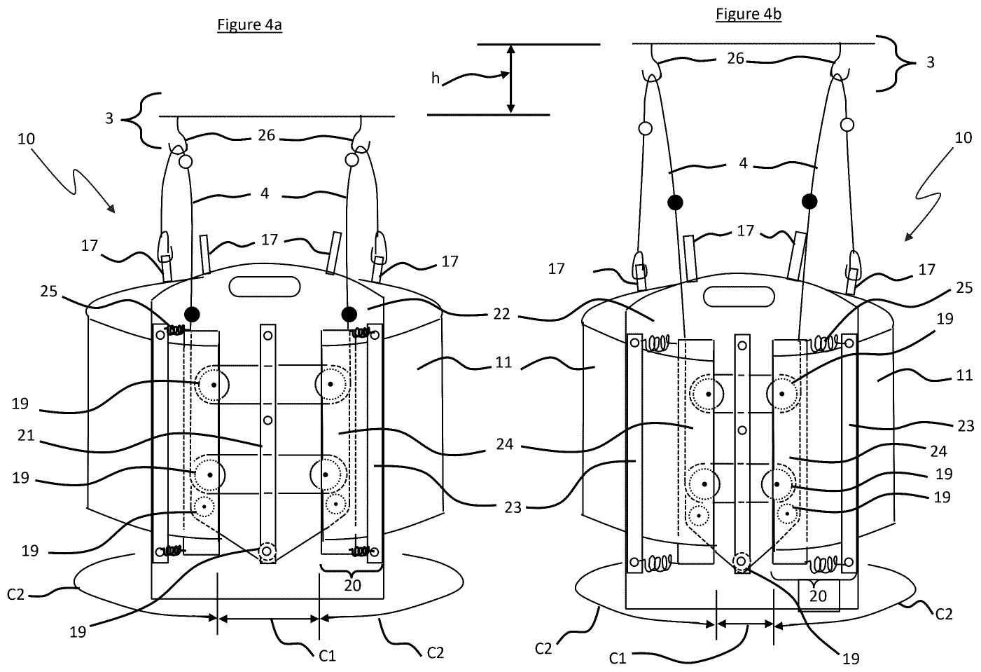

FIGS. 4a) and 4b) show further views of the friction-lift torso harness (10) of FIG. 3, unobstructed by the cover (18) and illustrating the effect of movement by the lift wires (4).

The patient lift hoist (3), includes a pair of lift hooks (26), as shown in FIGS. 4a, b), whereby the lift wires (4) pass over the lift hooks (26) as the lift wires (4) extend between the lift tabs (17) at the front of the harness band (11) and the tensioning mechanism (12) on the opposing, rearward side of the harness band (11). The effective lift point, being the physical point or position at which the weight of the patient (2) in the friction-lift torso harness (10) is lifted by the patient lift hoist (3), may be represented by a variety of configurations. In the embodiment shown in at least FIGS. 4, 11, 12, 13 and 16, the lift point is located at the lift hooks (26).

FIG. 4a also shows the circumferential distances C1 and C2:
C1 is the distance between the pulley mounting bars (24) within the tensioning mechanism (12), and
C2 is the distance traversed by the harness band (11) between the pulley mounting bars (24).
C is the total circumference traversed by the friction-lift torso harness (10) extending about the patient's torso and is equal to C1+C2,

It may be readily seen by comparing FIGS. 4a and 4b), that raising the lift hoist (3) (in FIG. 4b)) and extending the lift wires (4) from the tensioning mechanism (12) causes the pulley mounting bars (24) to be drawn together, thereby decreasing C1. As C2 remains unchanged during the decrease of C1, consequently C also decreases. An exemplary circumstance demonstrating such a dynamic, occurs after the friction-lift torso harness (10) has been fitted closely, but not uncomfortably tightly, to a seated patient. Raising the lift hoist (3) (and, consequently, the attached lift hooks (26)) by a vertical distance h, causes the harness spreader bars (20) to be pulled together, hence reducing the circumference C of the friction-lift torso harness (10) around the torso, and increasing the compressive force applied to the patient (2). Once the compressive force created by the tension in the friction-lift torso harness (10) reaches a threshold value, the lift wires (4) will cease extending from the tensioning mechanism (12) and the lift force will be sufficient to start raising the patient (2).

It is helpful to illustrate the underpinning physics of such lifting operations utilising an interaction of tension, compression, and friction forces.

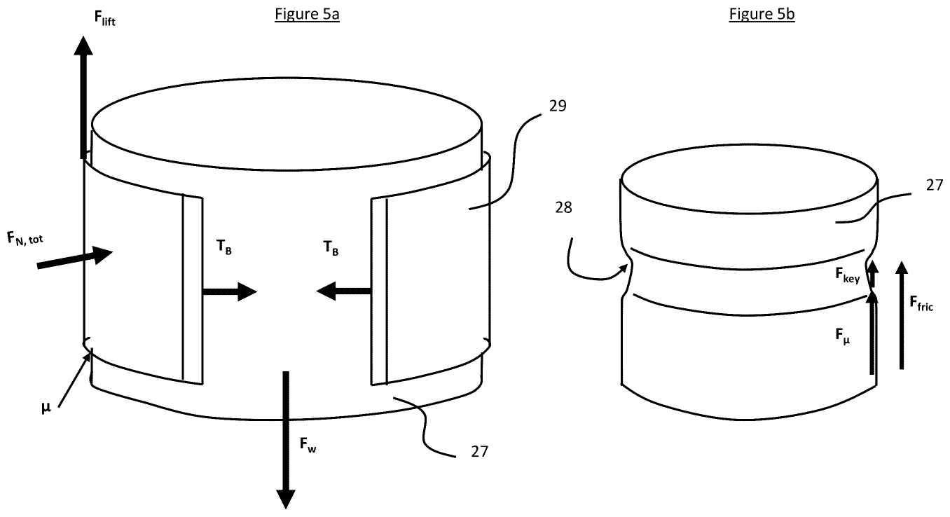

FIGS. 5a) and 5b) show a simplified schematic of the forces involved in deriving how a tensioned encircling band lifts an object via friction force.

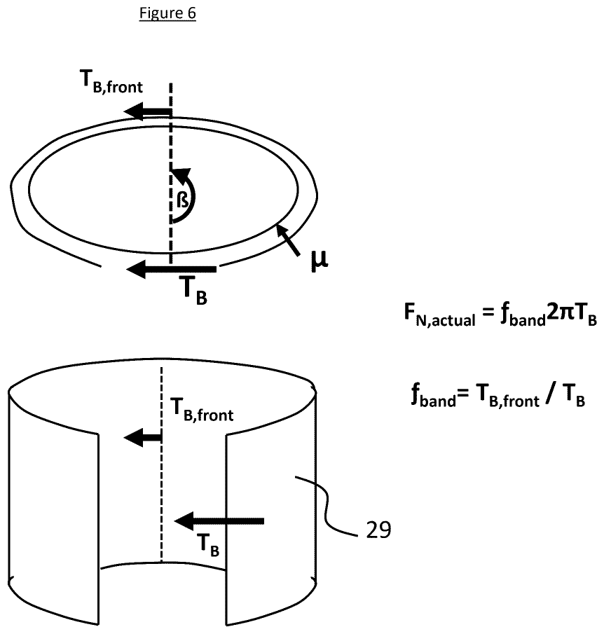

FIG. 6 is a schematic showing how the tension in a tensioned band reduces as the band is pulled over the surface of the object.

To facilitate the following derivations, the lateral exterior of an idealised human torso may be conceptually represented as a cylinder (27) as shown in FIG. 5a). In recognition of the reality of human anatomy (and as shown in FIG. 5b)), the lateral exterior of the human torso is not uniform and includes regions of irregularity and/or lateral projections (28) such as the lower extremity of the rib cage that are not parallel with the sides of the cylinder (27). In circumstances (as shown in FIGS. 5a-b)), where the cylinder (27) is orientated with its rotational axis vertically, corresponding to an upright torso, it follows such lateral projections/recesses (28) are non-vertical. Note, a recess or a projection from the plane of the cylindrical surface may be considered functionally equivalent for the purpose of this analysis and are thus both encompassed by the term projection.

Lifting the weight of a patient (2) by a frictional force between the patient's (2) torso (conceptually represented by cylinder (27)) and a compressive friction-lift torso harness (10) (conceptually represented by a tension or tensioned band (29) in FIGS. 5a) and 6)) can be derived from the mathematic description of the mechanism by which a tensioned band (29) can lift a mass by both friction and any vertical force (a vertical force acting on non-vertical elements of the shape), and determining the required parameters of the compressive friction-lift torso harness (10) to ensure a successful lift.

Summing the forces in the vertical direction requires that total lift force, F_{lift}, be equal to the total weight force of the lifted mass, F_{w}, which is described by the equation:

$${F}_{lift} = {F}_{w} \qquad ( i )$$

As represented in FIG. 5b, the vertically upward force lifting the mass consists partially of a friction force, F_{μ}, between the band and the surface of the mass and partially from phenomena known as mechanical keying, i.e., from a small component due to the tensioned band engaging with any protrusions or non-vertical projections (28) in the sides of the mass, referred to herein as F_{key}. Axiomatically, any keying force only arises due to the presence of the tensioned band (29) and although in the case of a human torso, a relatively small component, the proportion of the contribution of each of these forces is impractical to determine. Therefore, this issue is addressed by combining the two upward force terms into a single term for frictional force, i.e., F_{fric}.

F_{fric} is calculated using the effective value of the co-efficient of friction between the band and the mass/body—μ_{eff}, rather than a solely frictional value measured between two abutting flat surfaces, as typically reported in materials literature. Commonly, friction force, F_{fric}, is calculated as:

$${F}_{fric} = {μ}_{eff} {F}_{N , tot} , \qquad ( ii )$$

where F_{N,tot} is the total normal force acting on the body from the tensioned band and μ_{eff} is the effective coefficient of friction.

In a simple case, the coefficient of friction used would be that between the surface of the mass and the tensioned band. Where there are multiple layers of fabric that can slide against one another, such as is commonplace for a person wearing layers of clothing between themselves (i.e., the mass) and the tensioned band, then the lowest value of coefficient of friction found between layers would be used.

Naturally, it would be possible for a person to wear two adjacent layers of low friction material which would create a very low value of friction and thus make lifting a person via friction non-viable. It can be understood that, as a part of a preparatory protocol for using the disclosed embodiment, the nursing staff, carers or anyone assisting in the patient handling would pre-emptively check if unsuitable garments were being worn.

It should be noted that even if such clothing is not pre-emptively detected, use of the friction-lift torso harness (10) will not result in a potentially harmful slip of a raised patient (2) from the friction-lift torso harness (10), as the patient (2) would not have been lifted successfully from their seated position in the first instance.

The harness band (11) is made from a high friction material to grip strongly to the external surface of the patient's (2) clothing. Fortunately, the coefficient of friction between common clothing material such as cotton or polyester and a humans' skin has a known value of approximately μ=0.4. In the case of cotton-on-cotton or any other combination of common materials, the coefficient of friction has a higher value than 0.4. Therefore, the interface most likely to cause slipping is not between two clothing layers, but between a patient's skin and the immediately adjacent layer of clothing. There is thus a robust basis to conclude that a value of μ=0.4 is a sound base-value assumption for the following analysis.

In the following analysis, it is desirable to be able to effectively use a common value of μ_{eff}. If a particular patient's μ_{eff} is larger than the predetermined common μ_{eff} value, due, for example to their specific body shape or the high friction coefficient material of their clothing, they would be still lifted with the same band tension as someone with a coefficient closer to, or with, the common μ_{eff} value. The compressive force would be larger than is necessary for their particular value of μ_{eff}.

However, it is clearly impractical to accurately measure each patient's μ_{eff} in advance in order to appropriately adjust the friction-lift torso harness (10) tightening properties. Nevertheless, the above framework is designed to lift a patient with the lowest co-efficient of friction that might be expected to be typically encountered, while still lifting other patients, albeit slightly tighter than the minimum force required.

Substituting the equation for friction force into the vertical force equation gives:

$${F}_{w} = {μ}_{eff} {F}_{N , tot} , \qquad ( iii )$$

In the case of a tensioned band that completes a 360° (2π radians) wrap i.e., a full wrap of the torso, the calculation for the total normal force applied by the band to the body/mass is the well-established equation:

$${F}_{N , tot} = 2 π {T}_{B} , \qquad ( iv )$$

where T_{B} is the tension throughout the band. This equation for the normal force derivation is based on the assumption of equal tension throughout the band.

As the band is being tensioned at a single location on the circumference, (i.e., between the two spreader bars) and is being drawn around the body, it runs over the surface of the body and will consequently see a reduction in band tension due to the friction against the surface. FIG. 6 depicts this tension-reduction schematically.

The tension reduction, or loss, may be quantified by application of the well-established Capstan Equation, which calculates the loss of tension in rope or band being pulled over a curved surface. The Capstan Equation can be applied to this scenario as:

$${T}_{B , Front} / {T}_{B} = \frac{1}{{e}^{μ β}} \qquad ( v )$$

where T_{B,front} is the tension of the band in the front of the band (180° away from the spreader bars), and T_{B} is the applied tension at the bars, B is the angle of wrap that the band goes around the curved surface and μ is the coefficient of friction between the band and the surface, i.e., between the patient's skin and adjacent first layer of clothing.

As β=π radians for 180° and μ=0.4 for a skin-clothing interface, the ratio of the force in the band at the front and at the tightening bars is calculated as:

$${( {F}_{B , front} / {F}_{B} )}_{ideal} = 1 / {e}^{( 0.4 π )} = 0.2 \; 85 \sim 0.3 , \qquad ( vi )$$

given the corresponding degree of accuracy to which the co-efficient of friction values are known. The value of (F_{B,front}/F_{B})_{ideal} of ˜0.3 suggests the tension at the front of the band is equal to 30% of the tension applied at the spreader bars.

In practical usage however, the body compresses as the band tightens and the relative motion between band and body is not consistent at all angles. These two effects deviate from the assumptions used to derive the Capstan Equation and consequently experiments were performed to determine a practical value.

Experimentation determined the ratio to be approximately:

$$( {T}_{B , Front} / {T}_{B} ) expm \approx 0.6 \qquad ( vii )$$

This implies that the band tension at the front is 60% of the tension applied at the tightening bars of the band. It can be assumed that the tension reduces approximately linearly along the circumference of the body and therefore the average band tension can be approximated simply as the average of front and back tensions. As the tension is 60% at the front, and 100% at the spreader bars, the average is as calculated by:

$${f}_{band =} ( 1 + 0.6 ) / 2 = 0.8 . \qquad ( viii )$$

The average value found can be used as a modifying factor, f_{band}, which modifies the total band tension used in our calculation of total normal force relative to band tension.

In an embodiment where two sets of harness spreader bars (20) are used and the tension is applied at two points, the largest angle over which tension loss occurs would be 90°, in which case the tension would only reduce to 80% at most. In accordance with the above calculations to determine the average value, it can be shown that f_{band}=0.9 when two sets of spreader bars are used.

The equation for total normal force applied to the body by a tensioned band fully wrapping about the body from spreader bars at one point on the circumference, can be given as:

$${F}_{N , tot} = {f}_{band} 2 π {T}_{B} = ( 0 \text{.8} ) 2 π {T}_{B} \qquad ( ix )$$

It would thus follow that the more sets of spreader bars used, the closer f_{band} will tend to 1, notwithstanding the physical impracticality of adding more than two sets of spreader bars.

An important function of the friction-lift torso harness (10) is that the tension in the harness band (11) at the harness spreader bars (20) is determined by properties of the tensioning mechanism (12). The tensioning mechanism (12) converts the lifted weight force into tension in the harness band (11).

As defined herein the Proportional Forcing Factor (PFF) k_{pff}_{^{PFF}}, as the relationship between lifted weight force, F_{w}, and the applied band tension at the tightening bars, T_{B}, given by

$${k}_{{pff}^{PFF}} = {T}_{B} / {F}_{w} . \qquad ( x )$$

Taking the earlier equation (iii) for F_{w} and substituting for F_{N,tot} and then substituting T_{B} for a rearranged version of the k_{PFF} equation (x) gives:

$${F}_{w} = {μ}_{eff} {f}_{band} 2 π {k}_{pff} {F}_{w} . \qquad ( xi )$$

Cancelling like terms and rearranging for k_{PFF} provides an equation for determining the required relationship (i.e., the PFF, or k_{PFF}), between lifted weight force and band tension, for a given coefficient of friction, μ_{eff}, namely;

$${k}_{{pff}^{PFF}} = 1 / ( 2 π {μ}_{eff} {f}_{band} ) \qquad ( xii )$$

Thus, for a patient (2) with a given effective coefficient of friction, μ_{eff}, a PFF greater than a predetermined lift-threshold PFF may be required to ensure the weight being lifted by the friction-lift torso harness (10) will not slip. Although the lifting vest will apply greater compressive force to the patient's torso than the minimum necessary for lifting, a patient (2) who may require a PFF lower than the given lift threshold (due to a higher μ_{eff}) will still be ensured of a secure lift. In seeking to maximise the comfort and safety of each patient (2) during each patient handling procedure, it is important to ensure a patient (2) will not slip from the friction-lift torso harness (10) after being raised from their seated position. Consequently, a moderate degree of additional compressive force applied to the patient's torso is a preferable compromise to ensure such safety.

As readily understood to one skilled in the art, it is impractical to determine each individual patient's μ_{eff} without testing, particularly given it will vary depending on their clothing and physical condition. Therefore, it is desirable to determine the lowest μ_{eff} that would likely be encountered in a normal spectrum of patients to set a lift-threshold PFF value and accept that any individual patient (2) with a higher μ_{eff} will still be safely raised, albeit with the temporary effects of an increased compressive force and any associated discomfort that may produce.

It has been established through experimental research that in this application, the effective coefficient of friction for a patient (2) is between μ_{eff}˜0.4-0.5.

Thus, using the median value of μ_{eff}=0.45 and f_{based}=0.8 (for a system with a single set of spreader bars, referred to as a ‘spreader set’) gives the result;

$${}_{PFF} 1 / ( 2 π {μ}_{eff} {f}_{band} ) = 0.44 , \qquad ( xiii )$$

where the result is rounded to 1 significant figure, given the level of μ_{eff} accuracy.

Thus, for a compressive friction-lift torso harness (10) to lift a patient's torso solely by the effective frictional force (i.e., without any lift straps about the patient's limbs), the mechanism by which the lifted weight force is converted into tension about the torso may have a PFF value of at least k_{PFF}≥0.4.

While some prior art lifting and/or patient handling devices have used the general principle of using a person's body weight to tighten some form of a vest or torso band, these devices are intended to either provide patient stability (not patient lifting) or are used in conjunction with other means to achieve patient lifting (leg straps, groin straps, axilla slings knee pads and the like. Consequently, none of these devices have demonstrably achieved a PFF value of k_{pff}_{^{PFF}}≥0.4.

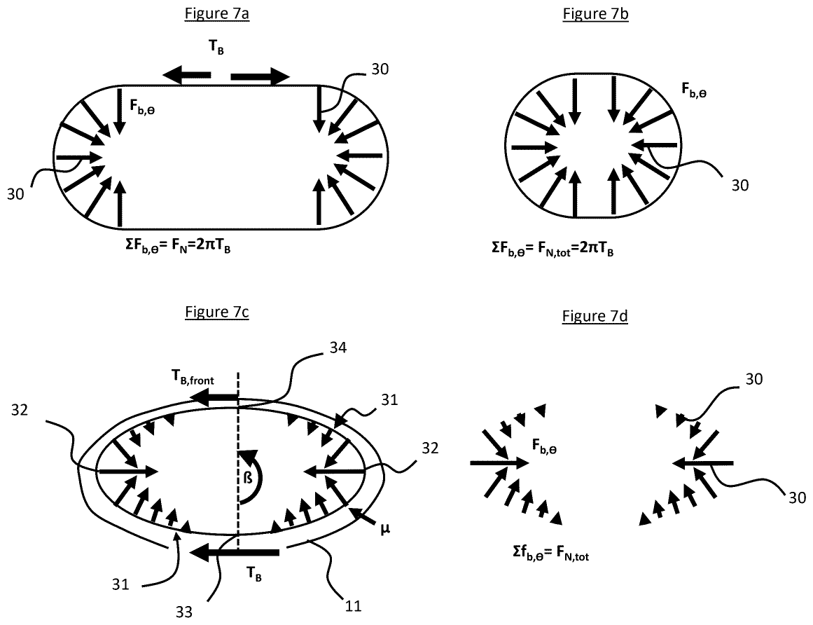

It will also be appreciated that a human torso is not uniformly circular in the transverse plane, being closer to an oblate ellipsoid. FIGS. 7a-c) depict visual representations of different ellipsoids illustrating further analysis of the nature of any compressive forces being applied to the patient's torso.

As is well established, the normal force applied by a tensioned band at any point is inversely proportional to the radius of curvature. Thus, for a band portion traversing a tighter bend (i.e., a smaller radius of curvature), the normal force is larger. Conversely, portions of the band adjacent straight sections (i.e., an infinite radius of curvature), the normal force is zero. These characteristics are clearly illustrated in the exemplary FIGS. 7a and 7b) by force arrows (30), representing the direction and magnitude of normal force acting on a shape with straight parallel sides, joined by symmetrical constant curvature opposing ends.

Regarding a transverse view of a human torso (as shown in FIG. 7c), most exhibit a characteristic elliptical exterior shape (31) which would experience larger normal forces around the lateral sides (32) where the curvature is smaller, and smaller normal forces anteriorly or torso anteriorly (34) and posteriorly or torso posteriorly (33) where the radius of curvature is much larger i.e., almost flat. FIG. 7d) allows the visualisation of the forces disposition shown in FIG. 7c) without the complication of the torso circumference (3) outline.

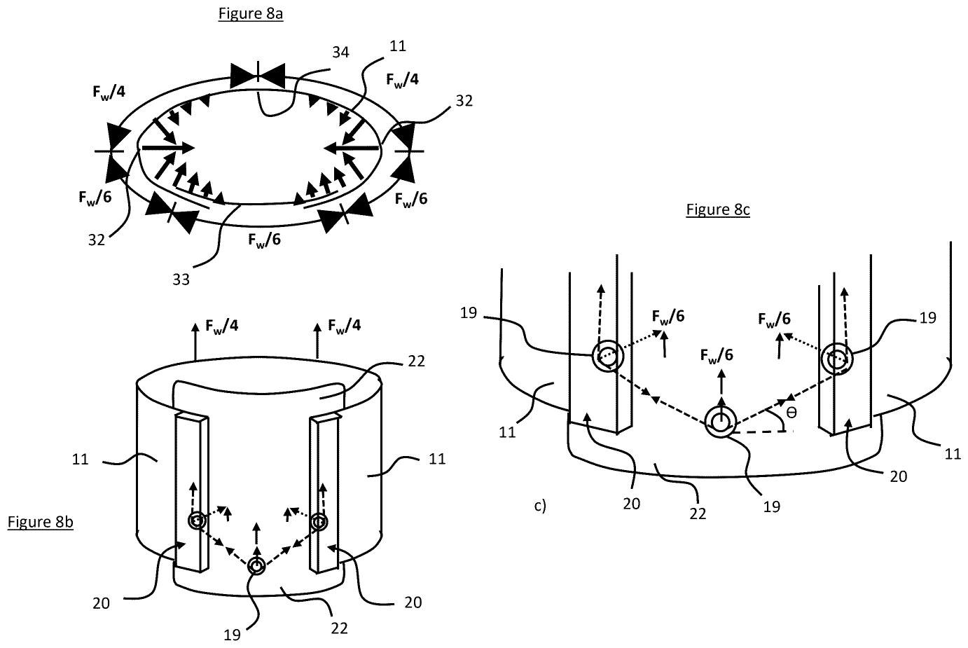

FIGS. 8a-c) illustrate how the distribution of the lifting force applied about the friction-lift torso harness (10) differs, and some consequences thereof. A practical consequence of a tensioning band-type configuration is the likely necessity for some form of physical barrier to protect clothing or skin from being entrapped or otherwise impinged by movement of the spreader bars (20). In addition to causing potential patient (2) discomfort, any bunching or interference with the patient's clothing restricts the freedom and efficiency travel of the spreader bars (20), thus reducing the tension generated in the harness band (11). The protection of a physical barrier is again provided by of a bridge panel member in the form of flexible back board (22).

In order to minimise friction loses, it is desirable to minimise the friction interaction as the spreader bars (20) slide over the back board (22) surface, to avoid loss in the tension of the harness band (11) by increasing the f_{band} value. However, a counter-productive consequence of such a configuration is that a low friction back board (22) in direct contact with the harness band (11) lowers the overall coefficient of friction (μ_{eff}) between the patient (2) and the harness band (11), thus increasing the required PFF value of k_{PFF}. Consequently, in practice this causes the patient (2) and back board (22) to slide relative to the friction-lift torso harness (10) as it fails to generate sufficient tension to reach the PFF lift-threshold.

In order to allow the harness band (11) to efficiently tighten and prevent the backboard slipping, an effective solution is to connect one of the lift wires (4) about a pulley (19) mounted directly on the back board (22). FIGS. 8b and 8c) show such a configuration with a pulley (19) mounted centrally, directly on the back board (22), or alternatively with the centre pully (19) attached to the back board (22) via a centre spreader bar (21) (as shown in earlier FIGS. 3-4).

FIG. 8a) shows a medial view of the distribution of the vertical force distributed circumferentially about the patient's torso by the friction-lift torso harness (10) being transferred from the patient (2) to the back board (22) by a simple ratio of contact areas. It can be seen that the two anterior quarters of the harness band (11) each account for lifting approximately ¼ of the lifted weight. Posteriorly, it can be seen approximately ⅙th of the lifted weight is distributed through the back board (22) and a further ⅙th via the harness band (11) portion either side of the back board (22). Therefore, the angle θ made by the lift wire (4) passing about the centre pulley (19) may be set such that the calculation of upward force on the back board (22) centre pulley (19) is approximately ⅙th of the lifted weight force. Although an approximation, such a setting is effective due to a self-regulatory characteristic of the configuration, i.e., if the calculation of angle θ is incorrect, the back board (22) simply slides downwards until the angle θ of the lift wires (4) results in sufficient upwards force on the back board (22) via the centre pully (19) to prevent slippage, thus obviating the need for additional and/or more accurate calculation.

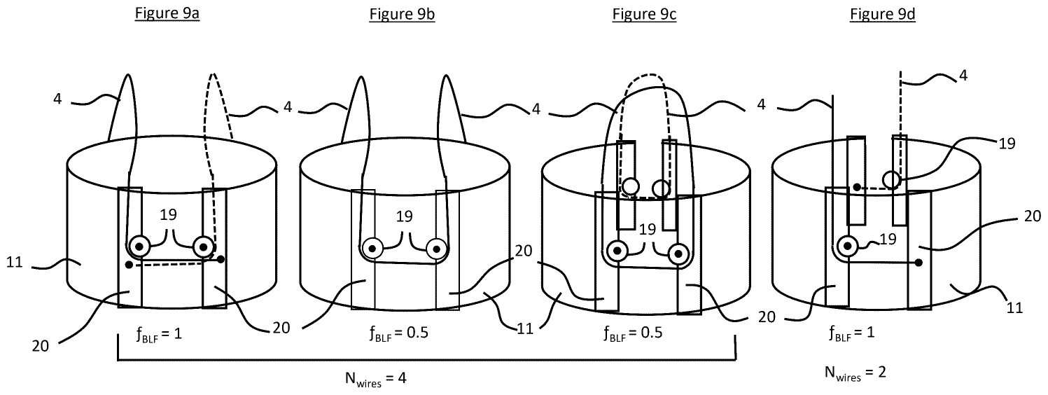

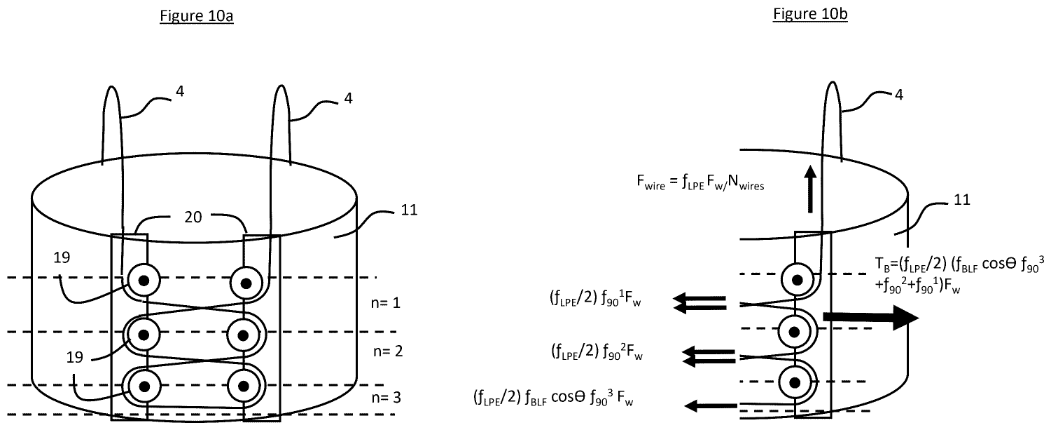

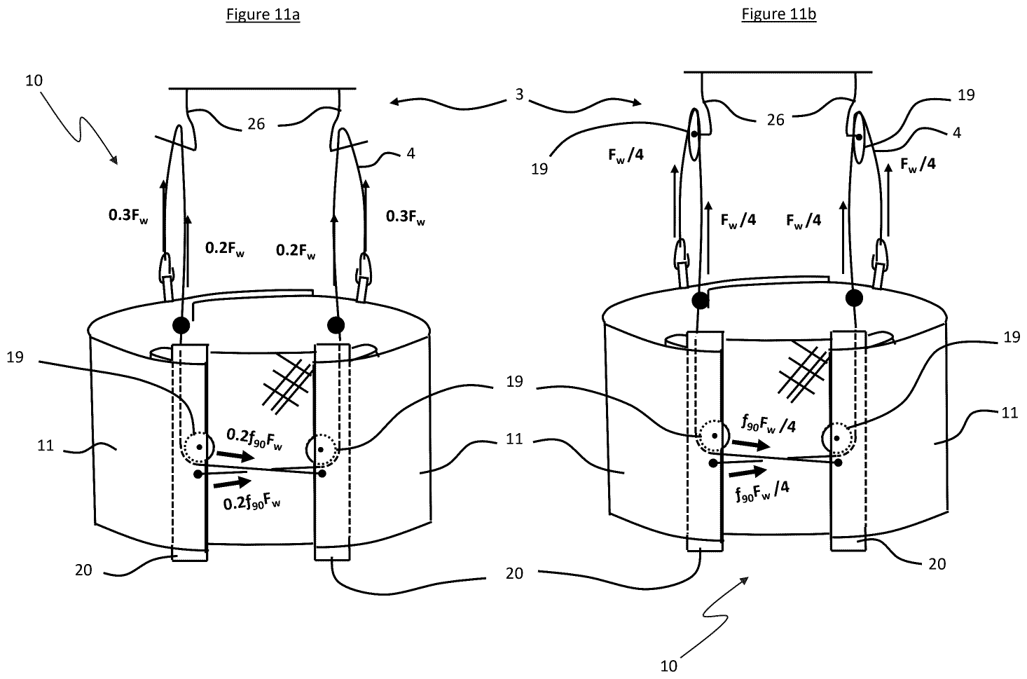

FIGS. 9a)-d) show schematic representations of alternative pulley lacing patterns and the factors assigned to properties used in the analysis of the patterns.

The ratio by which the friction-lift torso harness (10) transfers force from the lift wires (4) into harness band (11) tension can be determined by analysing the lift wire (4) lacing pattern between the harness spreader bars (20).

While it will be well understood there are numerous possible lacing patterns, many of the practical embodiments can be considered with the following generalised approach.

FIGS. 9a-9d shows alternative wire lacing options according to the number of lift wires (4) employed. Largely for practical reasons, typically two or four lift wires (4) are used, categorised according to the total number of separate wires which support the lifted weight. It will be understood by those in the art, that a single wire option isn't viable, while a three wires configuration can essentially be considered the same as two or four wires in this analysis, as a balanced system will result in loading one of the three wires with double the force of the other two. Lacing numbers greater than four wires become impractical in distributing load evenly and/or by the number of spreader sets needed.

Where the number of lift wires (4) is four (as shown in FIGS. 9a-c), there will always be two lift wires (4) crossing to the opposite spreader bar (20) from the side the lift wires (4) began, per lace step, creating a multiplying factor of two in terms of force applied to the spreader bar (20). Where there are two lift wires (4) (as shown in FIG. 9d)), the wire only crosses from one spreader bar (20) to the other spreader bar (20) without a returning counterpart and thus a multiplying factor of one is applied. Therefore, where appropriate in this analysis, a factor of (N_{wires}/2) may apply.

Another consideration to be incorporated as appropriate is the differing configurations that can occur at the origin/terminus of the wires, typically located at the bottom of the tensioning mechanism (12). If the distal/terminal end of a lift wire (4) is anchored to the opposing spreader bar (20) (as shown in FIG. 9a) and 9d)), there will be two times the lift wire force between the spreader bars, such as suggested by the above (N_{wires}/2) factor and a Bottom Lacing Factor of f_{BLF}=1 is applied (as shown in FIG. 9a)). Where the bottom lift wire (4) is connected to another lift wire (4) from the opposing spreader bar (20) (as shown in FIGS. 9b and 9c)), the force generated between the spreader bars is equivalent to a single multiple of the lift wire force so a modifying term of f_{BLF}=0.5 is applied.

The embodiments presented in FIGS. 9a)-9d) represent a single lacing step. It is desirable to add additional lacing steps or stages to increase the Proportional Forcing Factor (PFF) of the vest. The embodiment depicted in FIG. 10 shows a three-step lacing pattern. It should be noted that the lacing pattern is depicted with an exaggerated wire angle traversing between the spreader bars (20) for clarity and comprehensibility purposes only. In actuality, the wires would be effectively parallel as they cross between spreader bars (20).

Included in this analysis are losses due to friction as the lift wires pass around a 90° or 180° redirection. These losses can be measured by experiment or, depending on the mechanism that creates the redirection, calculated by the Capstan Equation for a band over a smooth curved surface, or analysis of a pulley running on axle where pulleys are utilised. The term for loss over a redirection of say 90° is denoted as f₉₀.

Generally, a measurement obtained through experiment provides the most accurate information for a particular configuration, such as, for example, a webbing strap through a metal ring, where a standard equation doesn't accurately approximate, or where theoretical pulley calculations are idealised and don't account for unexpected real-world losses. In the theoretical analysis for friction loss due to a redirection, common equations suggests that f₁₈₀=f₉₀², but in experiments of ropes and straps over rings and of pulleys, other factors have large effects on the outcome and in practice, experimentally derived measurements show that f₁₈₀ is approximately equal to f₉₀ for these applications.

If a one-step lacing system (where N=1) was considered, the number of redirections of the horizontal force between the spreader bars (20) to a vertical direction aligned toward the lifting hooks, is equal to one. Therefore, the force between spreader bars (20) which is equal to the tension in the harness band (11) will be defined by the equation:

$${T}_{B} = {f}_{BLF} ( {N}_{wires} / 2 ) cos Θ {f}_{90}^{1} {F}_{wire} , \qquad ( xiv )$$

where cos θ is used to modify the force between spreader bars (20) if a bottom centre pulley (19) or anchor point is included. If the bottom anchor point isn't included, θ=0 and cos θ=1 and the term is not modified for a horizontal lift wire between spreader bars.

For a system with two lacing steps, i.e., N=2, the equation for tension in the harness band (11) becomes

$${T}_{B} = ( {N}_{wires} / 2 ) {f}_{BLF} cos Θ {f}_{90}^{2} {F}_{wire} + ( {N}_{wires} / 2 ) {f}_{90}^{1} {F}_{wire} = {F}_{wire} ( {N}_{wires} / 2 ) ( {f}_{BLF} cos Θ {f}_{90}^{2} + {f}_{90}^{1} ) , \qquad ( xv )$$

in which it can be observed that the exponent on the loss term that represents the bottom lace increases given that more frictional losses have occurred in the wire between when it was initially vertical and reaching the bottom.

For a system with three steps, where n=3, the equation for tension in the band becomes

$${T}_{B} = {F}_{wire} ( {N}_{wires} / 2 ) ( {f}_{BLF} cos Θ {f}_{90}^{3} + {f}_{90}^{2} + {f}_{90}^{1} ) . \qquad ( xvi )$$

F_{wire} can be related directly to the lifted weight, F_{w}. In an idealised system, F_{wire}=F_{w}/N_{wires}.

In embodiments where the lift wires (4) pass over (but are not fixed to) lift hooks (26), the tension in the lift wire (4) passing into the tensioning mechanism (12) will be reduced due to friction at the lift wire/lift hook (4, 26) contact interface, and can be calculated as F_{wire}=f_{LPE}F_{w}/N_{wire}. Assigning a Lift Point Efficiency factor f_{LPE} can modify the relationship for F_{wire} to account for any losses. Therefore, substituting this equation into the equation for T_{B} for three lacing steps leads to:

$${T}_{B} = ( {f}_{LPE} {F}_{w} / {N}_{wires} ) ( {N}_{wires} / 2 ) ( {f}_{BLF} cos Θ {f}_{90}^{3} + {f}_{90}^{2} + {f}_{90}^{1} ) . \qquad ( xvii )$$

Rearranging F_{w} onto the left-hand side results in the equation for PFF, k_{PFF} given by:

$${k}_{PFF} = {T}_{B} / {F}_{W} = ( {f}_{LPE} / {N}_{wires} ) ( {N}_{wires} / 2 ) ( {f}_{BLF} cos Θ {f}_{90}^{3} + {f}_{90}^{2} + {f}_{90}^{1} ) = ( {f}_{LPE} / 2 ) ( {f}_{BLF} cos Θ {f}_{90}^{3} + {f}_{90}^{2} + {f}_{90}^{1} ) \qquad ( xviii )$$

Generalising this equation for any number of steps gives the equation gives:

$${k}_{PFF} = {T}_{B} / {F}_{W} = ( {f}_{LPE} / 2 ) ( {f}_{BLF} cos Θ {f}_{90}^{N} + {\sum }_{1}^{N - 1} ( {f}_{90}^{N} ) ) \qquad ( xix )$$

Equation (xix) can be used to calculate the expected PFF of any lacing pattern, subject to the following assumptions:
In the tensioning mechanism (12), the portions of lift wires (4) being redirected directly between the spreader bars (20) are orientated substantially parallel, and consequently, the applied tension in the lift wire (4) is substantially parallel to the direction of travel of the spreader bars (20) throughout their range of motion. Thus, the portions of lift wires (4) being redirected indirectly between the spreader bars (20) (e.g., the pulley (19), mounted on a centre spreader bar (21)) are not encompassed by the above assumption.
The lift wires are substantially vertical between the tensioning system (12) and the lifting hooks (26).

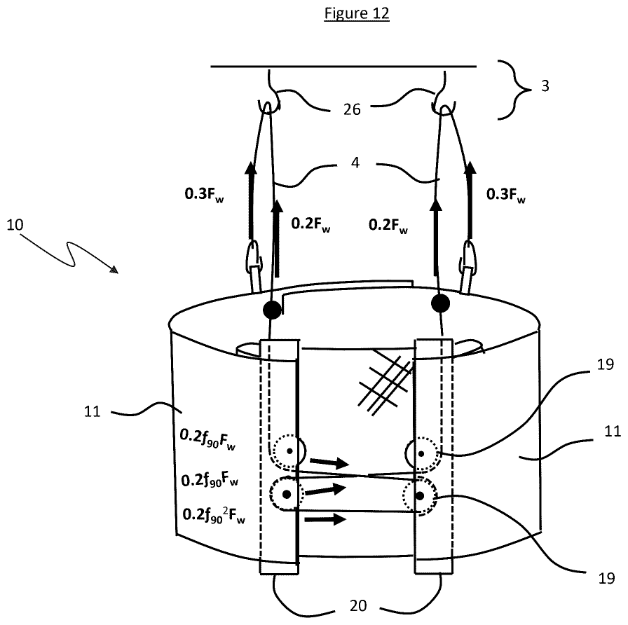

FIGS. 11a) and 11b) show schematic diagrams of alternative embodiments to illustrate how the application of a PFF calculation for the different specific k_{PFF}_{_{pff}} values demonstrates alternative methods and features that can be employed to achieve a successful lift threshold PFF value.

The friction-lift torso harness (10) shown in FIG. 11a) includes a tension mechanism (12) formed from a pulley system with two pulleys (19) on opposing harness spreader bars (20), interfacing with twin lift wires (4) passing from two frontal lift tabs (17), over two individual lift hooks (26) and terminating at separate attachment points on the opposing spreader bars (20). The embodiment shown in FIG. 9a) has the same configuration. Thus, we refer to the equation for k_{PFF} for a N=1 step embodiment, i.e., k_{pFF}=T_{B}/F_{w}=(f_{LPE}/2)(f_{BLF} cos θ f₉₀¹).

To determine the term f_{LPE} for the efficiency at the lifting point (i.e., the two lift hooks (26)), some analysis of the lift wires (4) may be required. While the sum of the tension force on all lift wires (4) adds to the total lifted weight force, the relative tension in each wire (4) may vary. In the embodiment shown in FIG. 11a) lift wires (4) are attached at the front of the patient (2) to the lift tabs (17) on the harness band (11). As the anterior portions of the lift wires (4) pull the lengths of lift wires (4) from the rear tensioning mechanism (12) over the lifting hooks (14), the lift wires (4) will lose tension due to friction with the lift hooks (26), resulting in the lift wires (4) at the front being at a higher tension than the rear, as shown.

The Capstan Equation can be used to calculate the loss of wire tension as wires run over the lifting hooks. It is known the Capstan Equation underestimates the tension loss when the wire is thin, the curved surface is small, and the forces are high relative to the rope strength. Therefore, we look to experimental results to determine the tension loss. From established literature and practical experiment, we can deduce a two thirds reduction in tension in the lift wires (4) from the posterior to anterior sides of the patient (2). Therefore, the two rear wires (4) each bear approximately 20% of the total lifted weight, 0.2F_{w}, and the two front wires each bear approximately 30% of the lifted weight, 0.3F_{w}. The four lift wires (4) thus sum 100% of the lifted force.

The embodiment in FIG. 11b) differs from that in FIG. 11a) only in that the lift hooks (26) include ball bearing pulleys (19). Assuming 100% efficiency for each ball bearing pulley (19), which is a reasonable approximation for this situation, all four lift wires (4) can be assumed to have equal force (i.e., 0.25F_{w}) and therefore f_{BLF}=1.

Therefore, the Lift Point Efficiency f_{LPE} for the embodiment of FIG. 11a) is the comparison between 0.2F_{w} and 0.25F_{w}, which equates to f_{LPE}=0.8.

Analysing first, the configuration for FIG. 11a), and assuming that it also has ball bearings in the pulleys (19) on each harness spreader bar (20) with corresponding values of f₉₀=0.9 for these, and f_{BLF}=1 as the wires (4) are anchored to the opposing pulley mounting bars (24).

As described previously, the equation for k_{PFF} is:

$${k}_{PFF} = {T}_{B} / {F}_{w} = ( {f}_{LPE} / 2 ) ( {f}_{BLF} cos Θ {f}_{90}^{1} ) , \qquad ( xx )$$

$${k}_{PFF} = ( 0.8 / 2 ) ( 1 cos ( 0 ) ( 0.9 ) ) = 0 \text{.36} , \qquad ( xxi )$$

which is below the lift threshold of k_{PFF}≥0.4 and therefore, this configuration would not lift the weight of a patient (2).

Considering the embodiment in FIG. 11b),

$${k}_{PFF} = ( 1 / 2 ) ( 1 cos ( 0 ) ( 0.9 ) ) = 0 \text{.45} \sim 0.5 , \qquad ( xxii )$$

which is greater than the lift threshold of k_{PFF}≥0.4 and therefore this configuration would lift the weight of a patient (2).

It can thus be seen that by maximising the force in the lift wire entering the tightening mechanism, the potential for achieving k_{PFF}≥0.4 is increased.

These embodiments also show the value of k_{PFF} achieved when ball bearing pulleys (19) are used is comparable to the k_{PFF} value obtained with plain (non-ball bearing) plastic pulleys without using as many lacing steps, therefore using less components and also requiring less wire to pull through the tensioning mechanism (12).

The schematic embodiment shown in FIG. 12 illustrates, in conjunction with the corresponding mathematical calculation of its k_{PFF}, demonstrates some alternative methods/features that can be employed to achieve a successful PFF lift threshold value.

If it is not desirable or practicable to use pulleys (19) at the lifting hooks (26), additional pulley cross-lacing steps can be added to increase the k_{PFF}.

Assuming the use of ball bearing pulleys (19) which provide 90% efficiency, the calculation of k_{PFF} is given by the equation:

$${k}_{PFF} = {T}_{B} / {F}_{W} = ( {f}_{LPE} / 2 ) ( {f}_{BLF} cos Θ {f}_{90}^{2} + ( {f}_{90}^{1} ) ) , \qquad ( xxiii )$$

in which f_{BLF}=0.5 as the two lift wires (4) connect together at the bottom of the tensioning mechanism (12) and f_{LPE}=0.8 given the losses over the lift hooks (26), then

$${k}_{PFF} = {T}_{B} / {F}_{W} = ( 0.8 / 2 ) ( 0.5 cos ( 0 ) ) 0.9 {(}^{2} + ( {0.9}^{1} ) ) , and \qquad ( xxiv )$$

$${k}_{PFF} = 0.522 \sim 0.5 , \qquad ( xxv )$$

given the degree of accuracy expectation for this analysis.

Therefore, the calculated PFF value of k_{PFF}=0.5 is greater than the lift threshold value for lifting a patient (2).

This analysis is to demonstrate that the configuration of the tensioning mechanism (12) can be altered to account for practical realities of the friction-lift torso harness (10) and the patient lift hoist (3) in order to maximise is its suitability for market requirements, where the key measure of success is determined by the identified PFF lift threshold value of k_{PFF}≥0.4.

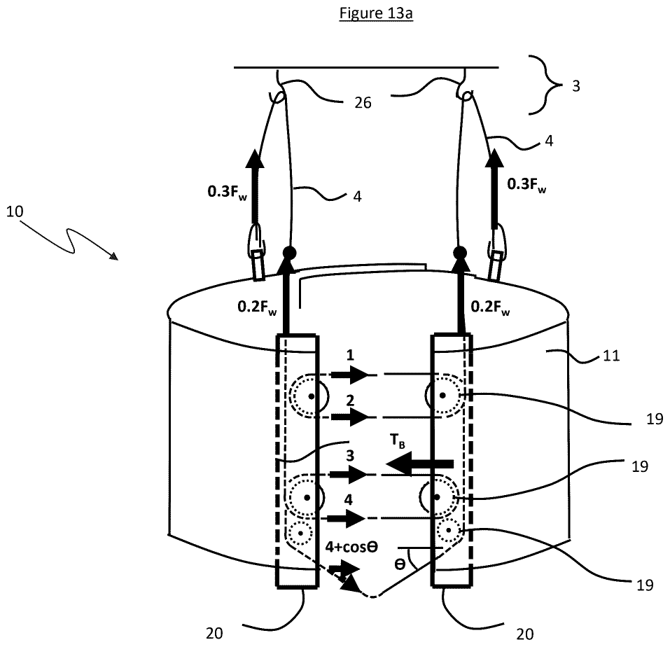

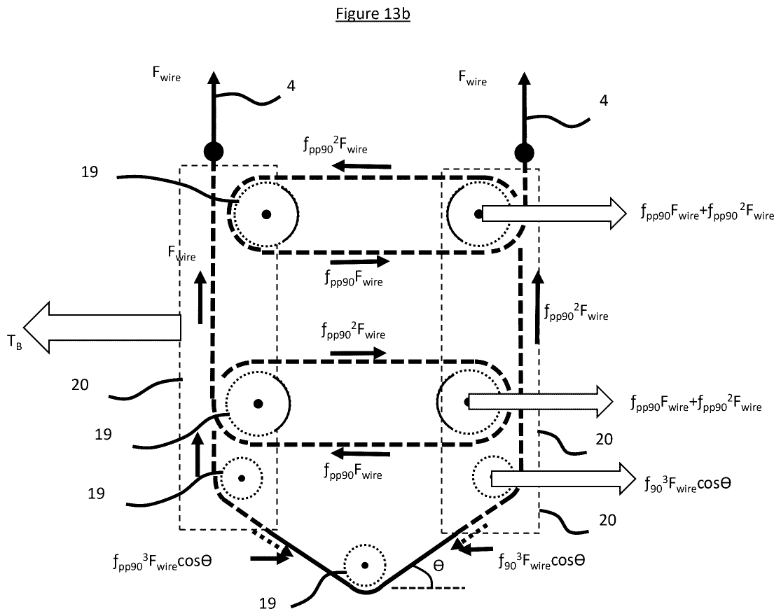

The embodiment shown in FIG. 13a) includes a pulley-operated tensioning mechanism (12), shown in greater detail in FIG. 13b). The primary function of a pulley (19) is to redirect a vertical force to horizontal force, in order to create tension in the harness band (11). The number of steps the lift wires (4) are laced between the harness spreader bars (20), determines the magnitude of force created between the spreader bars (20) and, therefore, the harness band (11) tension generated.

In a simplified assessment where no losses are considered, summing the horizontal force components of lift wires (4) that act equally on both sides of the harness spreader bar (20) is given by:

$${T}_{B} = ( 4 + cos Θ ) \cdot ( 0.2 ) {F}_{W} . \qquad ( xxvi )$$

Estimating θ=30°, gives

$${k}_{PFF} = {T}_{B} / {F}_{W} = ( 4.86 ) \cdot ( 0.2 ) = 0.972 = \sim 1 \qquad ( xxvii )$$

The PFF FIG. of k_{PFF}=−1 is approximately twice the required PFF lift threshold value of k_{PFF}=0.4, and therefore would easily lift a patient (2).

This embodiment also highlights the value of horizontally orientating the lift wires (4) spanning between the spreader bars throughout the travel of the spreader bars. If the lift wires (4) are non-horizontal through the travel of the spreader bars (20), the magnitude of the horizontal component of the wires (4) will also change. The previous equation developed for k_{PFF} does not incorporate any such change of angle, as it would reflect an unlikely and counter-productive design choice.

FIG. 13b) illustrates a more sophisticated analysis of the tensioning mechanism (12) shown in FIG. 13a), by taking into account the frictional losses incurred by passing the wires (4) over the multiple pulleys (19). The accuracy of the idealised ‘lossless’ calculation of k_{PFF}=1 is increased by consideration of the losses in the system.

Each time the lift wire (4) changes direction, either around a pulley (19) or a curve or edge, there will be a loss in the wire tension. Similarly, to the Capstan Equation, loss calculations for a curved surface have corresponding calculations that can predict losses over a pulley (19), based on the various aspects of pulley type and situation. The idealised calculations are often unable to accurately account for non-ideal conditions arising in practical pulley applications and therefore it is more useful and reliable to use experimentally derived values.

As an example, the pulley lacing configuration of the tensioning mechanism (12) in FIG. 13b) can be analysed by assigning some empirically derived values of losses for plastic pulley (19) of a given diameters and individual angle of lift wire (4) wrap about a given pulley (19).

While the pulley lacing pattern in FIG. 13b) differs slightly in visual appearance to that used earlier to derive the equation for k_{PFF}, it is effectively equivalent. Thus, equation (xix) can be applied where θ=30, f_{BLF}=0.5, f_{LPE}=0.8 and assuming that the efficiency of plain plastic pulleys (19) without ball bearings is f₉₀=0.7, then:

$${k}_{PFF} = {T}_{B} / {F}_{W} = ( {f}_{LPE} / 2 ) ( {f}_{BLF} cos Θ {f}_{90}^{3} + {f}_{90}^{2} + {f}_{90}^{1} ) \qquad ( xxviii )$$

$${k}_{PFF} = {T}_{B} / {F}_{W} = ( 0.8 / 2 ) ( 0.5 cos 30 {( 0.7 )}^{3} + {( 0.7 )}^{2} + {( 0.7 )}^{1} \qquad ( xxix )$$

$$and thus$$

$${k}_{PFF} = 0.5 \; 35 \sim 0.5 \qquad ( xxx )$$

for the degree of accuracy given the estimates of pulley loss.

Analysis of the tightening system thus determines that the PFF value is greater than the lift threshold value of k_{PFF}≥0.4 for lifting a patient (2).

As referred to earlier, the tensioning mechanism (12) may utilise other lift wire (4) turning elements (e.g., a ring, bar, round edge, fixed sheeve, capstan or the like) and not just pulleys (19). While pulleys (19) certainly offer advantages in terms of performance and efficiency, other means may be preferred in alternative embodiments.

In contrast to the embodiment shown in FIG. 13a), if pulleys (19) were replaced by non-rotational curved surfaces, a loss factor (comparative to a pulley (19)) of f₉₀=0.5 could be expected as the lift wires (4) pass around a type of round edge such as a ring or bar, i.e., 50% of the tension in the wire is lost.

FIG. 14 shows such an embodiment, where the pulleys (19) used in the embodiment in FIG. 13a) are replaced by fixed rounded sheeves (35).

Applying equations xxvii and xxviii, where θ=30, f_{BLF}=0.5, f_{LPE}=0.8 and assuming that the efficiency of a fixed plastic sheeve is f₉₀=0.5, then:

$${k}_{PFF} = {T}_{B} / {F}_{W} = ( {f}_{LPE} / 2 ) ( {f}_{BLF} cos Θ {f}_{90}^{3} + {f}_{90}^{2} + {f}_{90}^{1} ) \qquad ( xxxi )$$

$${k}_{PFF} = {T}_{B} / {F}_{W} = ( 0.8 / 2 ) ( 0.5 cos 30 {( 0.5 )}^{3} + {( 0.5 )}^{2} + {( 0.5 )}^{1} \qquad ( xxxii )$$

$$and thus$$

$${k}_{PFF} = 0 \text{.32} \sim 0.3 \qquad ( xxxiii )$$

This result is well below the PFF lift threshold of k_{PFF}≥0.4, and suggests that this configuration would not lift a patient (2). The term f₉₀³=0.125 (for f₉₀=0.5), suggest that adding more lift wire (4) lacing steps provides decreasing returns in the total harness band (11) tension, and therefore systems with low efficiency present in each in force redirection mechanism are inherently less likely to reach the desired threshold of k_{PFF}≥0.4.

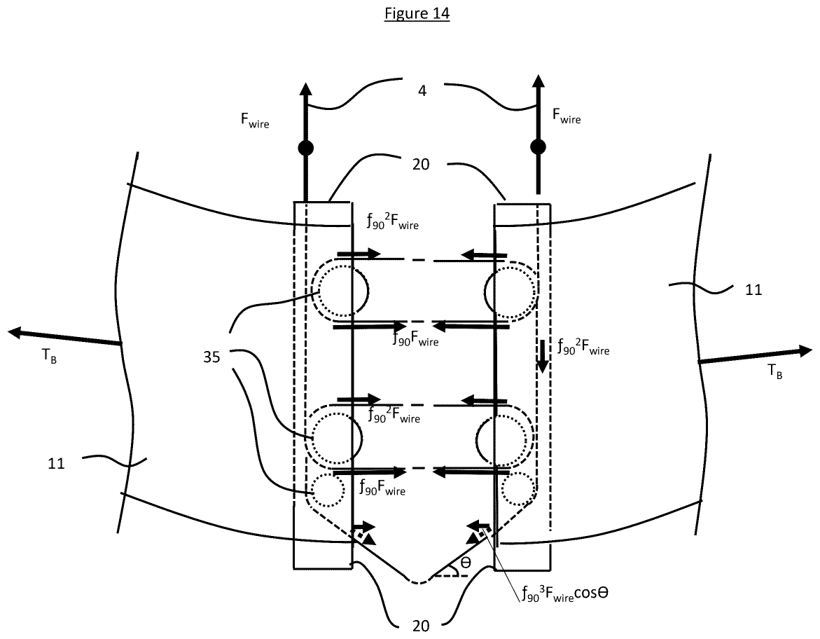

FIGS. 15a) and 15b) show a comparison of two embodiments with different tensioning mechanisms (12) and compares the amount of lift wire (4) that is drawn from the tensioning mechanism (12) as the spreader bars (20) move closer together during raising of a patient (2). The tensioning mechanism (12) of both embodiments have a PFF value of k_{PFF}=0.5, i.e., easily in excess of the lift-threshold PFF value.

The embodiment in FIG. 15a) is an efficient configuration with minimal friction losses as it employs ball bearing pulleys (19) in order to transfer the lifted weight force into tension in the harness band (11).

The embodiment in FIG. 15b) uses plain (non-ball bearing) plastic pulleys and draws the lift wires (4) over lift hooks (26) at the lifting point. Thus, the embodiment in FIG. 15b) includes a collection of features that exacerbate loss of tension in the lift wires (4) and reduce efficiency. A consequence of the lower efficiencies of the FIG. 15b) embodiment, is that an additional lift wire (4) is pulled from the tensioning mechanism (12), comparative to the embodiment of FIG. 15a). As a result, the patient lift hoist (3) needs to raise the lift hooks (4) a greater distance in order to create the same degree of movement 6d between the spreader bars (20). Conversely, for the higher efficiency configuration of the FIG. 15a) embodiment, the lift hooks (4) need to be raised less to achieve the same tightening effect.

Typical commercially manufactured patient lift hoists (3) are manufactured with a limited vertical lifting range. A certain fraction of this range is obviously needed for lifting a patient (2) from sitting to standing, and a further fraction is needed for tightening the friction-lift torso harness (10). If the friction-lift torso harness (10) is initially fitted to the patient (2) too loosely, thus needing to reduce in diameter by a large amount before beginning to lift the patient (2), this may not leave sufficient range to successfully raise the patient to the desired raised position. It is thus desirable that the amount of lift wire (4) drawn from the tensioning mechanism (12) in use is minimised.

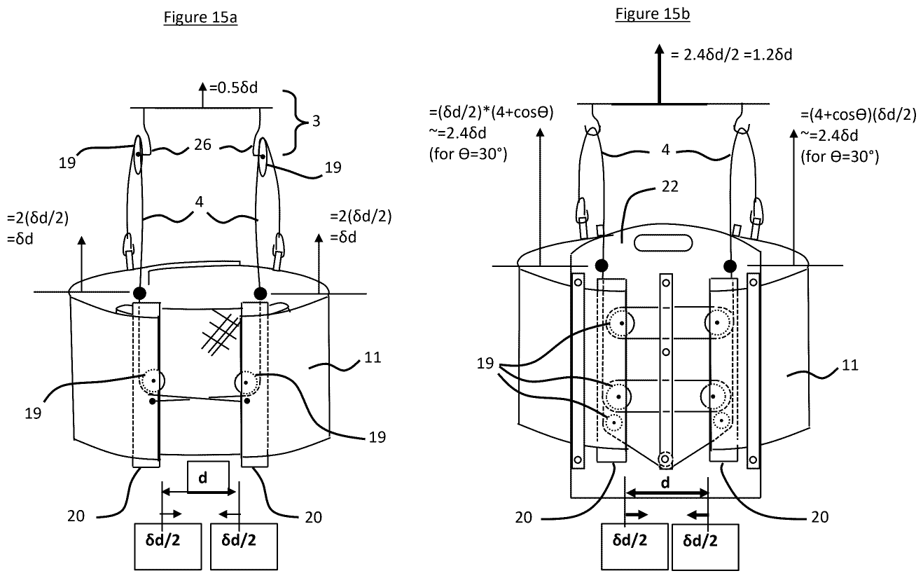

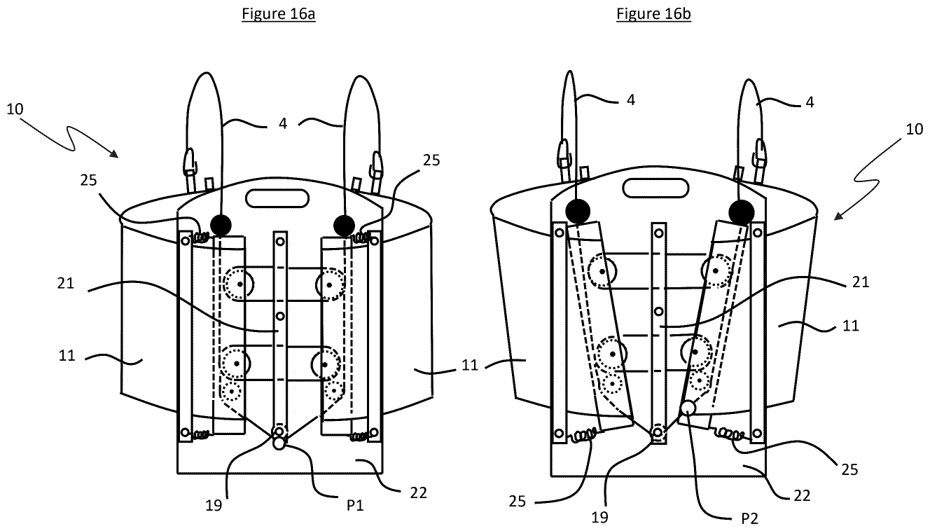

FIGS. 16a)-b) show the friction-lift torso harness (10) of FIG. 15b) and illustrate its capability to adapt to the individual ergonomic needs of the patient (2). The human body self-evidently does not have parallel sides, nor is it uniform in size or shape amongst any population globally or historically. It is thus important that the tensioning mechanism (12) of the friction-lift torso harness (10) allows the harness band (11) to conform with the differing bodies of patients (2).

The friction-lift torso harness (10) of FIGS. 15 and 16 are designed to accommodate variation in torso shapes by permitting the longitudinal axis of the two harness spreader bars (20) to be mutually non-parallel during use, i.e., allowing the spreader bars (20) to form a V, or inverted V-shape. Allowing a splayed V, or inverted V-shape for the spreader bars (20) allows the friction-lift torso harness (10) to match not only the shape of the patient, (who may, for example, have a proportionally larger upper torso, or lower thorax/abdomen) but also accommodate differences in the manner separate regions of the torso react to compression. As an example of the latter issue, typically, there is more change in stomach diameter than of the rib cage as the person is lifted. Thus, the circumference of the harness band (11) at the bottom decreases more, hence the lower region of the spreader bars (20) travels further during lifting. If the spreader bars (20) were fixed or otherwise constrained to remain parallel, the compressive force would be predominately applied to at top of the ribcage, while little, if any force would be applied to the stomach area as it couldn't continue to be tightened once the ribcage had reached its minimum compression diameter.

FIGS. 16a and 16b show a centre pulley (19) at the bottom of the centre spreader bar (21) which allows the harness spreader bars (20) to freely rotate to fit the shape of the patient (2) without needing to draw or release any lift wire (4) from the tensioning mechanism (12).

The white circle marker located on the lift wire (for reference purposes only) is located at position P1 at the centre pulley (19) when the spreader bars (20) are parallel (FIG. 16a) and then moves to position P2 to one side (FIG. 16b)) as the angle of the spreader bars (20) alters.

The joining of the two lift wires (4) at the centre pulley (19) location, together with the stabilizing effect of the centre spreader bar (21) provide a self-balancing characteristic during angular change of the spreader bars (20), in contrast to the embodiments shown in FIGS. 16c)-d).

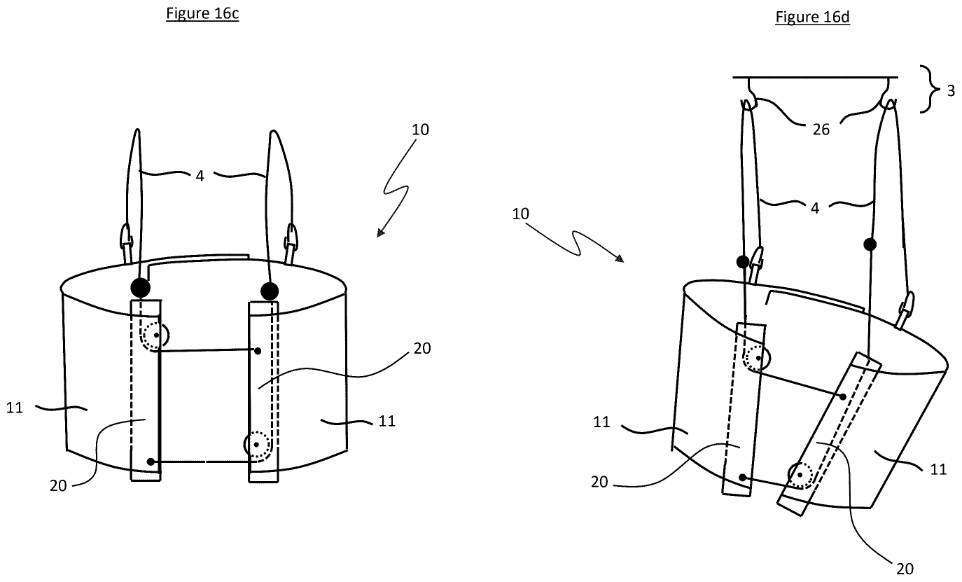

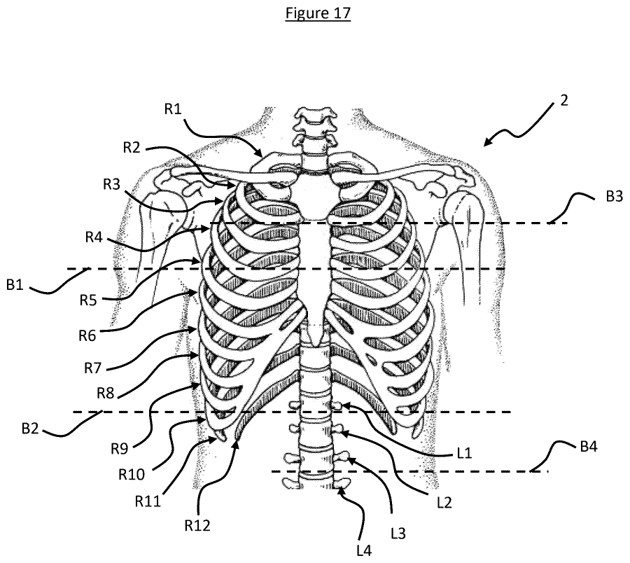

FIG. 17 shows the anterior skeletal structure and exterior surface of a human torso, indicating the respective positions of the recognised anatomical landmarks of the 12 ribs (individually, and successively indicated from the smallest, uppermost rib by R1, downwards to rib 12 denoted by R12). As previously described, in use, the disclosed embodiment applies a compressive force between at least two opposing exterior torso portions of the patient (2). While the compressive force may be applied to other portions, it is at least applied in the medial band of the torso between the 5^{th} and 10^{th} rib on at least two opposing exterior torso portions. FIG. 17 shows the upper medial boundary of the 5^{th} rib indicated by the line B1, and the lower medial boundary of the 10^{th} Rib indicated by B2. Optionally, the compressive force may also be applied beyond the boundaries B1, B2 up to an upper torso boundary B3, located at the axilla and a lower torso boundary B4, at the edge of the third lumbar vertebra L3.

The vertical position of the R5 and R10 ribs are taken at the ribs' lateral extremity in the sagittal plane.

It will be understood that due to the physical nature of a human torso, a compressive encircling element such as the friction-lift torso harness (10), will not necessarily be in intimate contact with the full peripheral boundary of the torso depending on the torso's shape and composition.

FIG. 18 shows embodiments utilising an individual lift point comprised of a single lift hook (4).

FIG. 18a) shows four lift wires (4) from the friction-lift torso harness (10) passing about a single pulley (19) at a single lift hook (26). FIGS. 18b) and 18c) respectively show embodiments with a single lift hook (26) without, and with, a halo spreader (36). A potential difficulty of using a single lift hook (26) without a halo spreader (36) (as per FIG. 18b)) is the risk of interference or entanglement of the lift wires (4) and the head of the patient (2). A halo spreader (36) offers a remedy for this difficulty by maintaining a safe separation between the lift wires (4) until well clear of the patient (2), as shown in FIG. 18c).

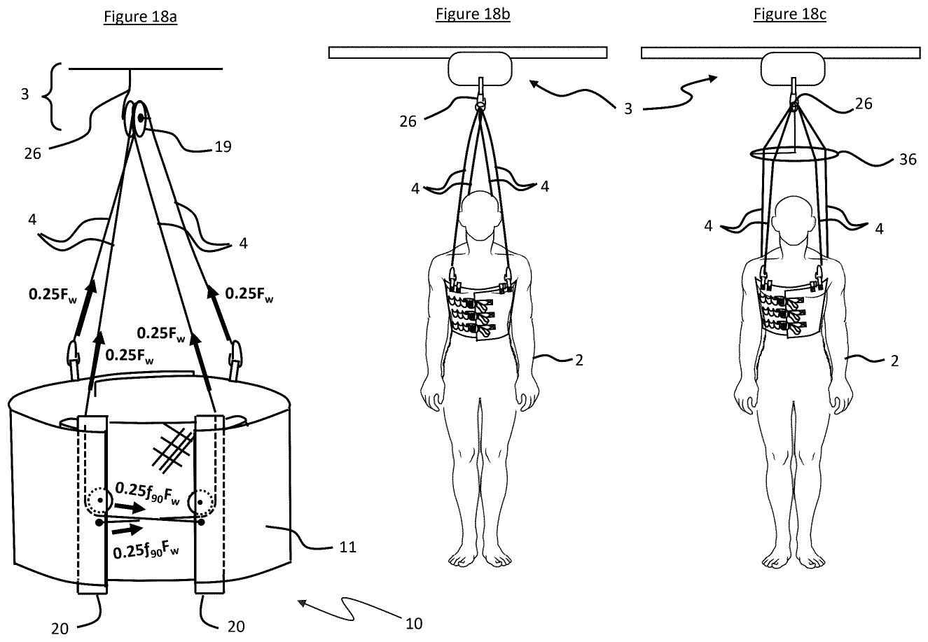

A further exploration of the configuration variables available to optimise the friction-lift torso harness (10) according to specific requirements is shown in FIG. 19.

In contrast to the preceding embodiments having a tensioning mechanism (12) with a single set of spreader bars (20) and associated pulleys (19) (hereafter referred to as a spreader set (37)), FIGS. 19a) and 19b) show an embodiment with multiple sets of spreader bars (20) and pulleys (19), i.e., multiple spreader sets (37). More specifically, it provides a tensioning mechanism (12) with a two spreader sets (37), each interlaced with a pair of lift wires (4). The two spreader sets (37) are connected to the harness band (11) to be positioned, when in use, at the front and back of the patient's torso. It will be appreciated that a tensioning mechanism (12) may be comprised of multiple spreader sets (37) and need not necessarily be restricted to one or two sets (37) as shown in the preceding embodiments. Due to the second spreader set (37) being located at the centre of the patient's chest, the central fastening (13) used in the previous embodiments is replaced by an offset fastener (13) in the form of a zip fastening (38).

It will be noted the embodiment shown in FIGS. 19a)-19b) also show the configuration of four separate lift wires (4) leading up to a lift point of four separate lift hooks (26). A benefit of individual lift wire/lift hook pairings (4, 26) is the elimination of tension losses incurred as a lift wire (4) is pulled over a lift hook (26).

In considering the PFF determination for the embodiment of FIG. 19, as previously discussed, we can assume the use of ball-bearing pulleys (19) give 90% efficiency, and therefore, using the previously defined equation (xix) for k_{PFF}, i.e., k_{PFF}=T_{B}/F_{w}=(f_{LPE}/2)(f_{BLF} cos θ f₉₀¹), then

$${k}_{PFF} = ( 1 / 2 ) ( 1 cos ( 0 ) ( 0.9 ) ) = 0.45 \qquad ( xxxiv )$$

Thus, as k_{PFF}=0.45 is greater than the PFF lift-threshold value of 0.4, the embodiment of FIG. 19 is able to lift a patient (2).

The PFF of a tensioning mechanism (12) can also be represented in terms of mechanical advantage (MA) and frictional efficiency (fₘ). The relationship is given as:

$$P F F = M A \times {f}_{tm} ,$$

where the Mechanical Advantage (MA) of the tensioning mechanism (12) is determined by observing or calculating the magnitude by which it converts the lifted weight into band tension—if no losses in the system are considered.

The efficiency at which the tensioning mechanism (12) transfers the lifted weight into band tension is given as a single term fₜₘ for the purpose of this explanation, representing the total frictional efficiency of the system in percent, i.e., 100% minus all frictional losses.

For a lacing system, the calculation of MA is determined by the tension in the lift wires (4), multiplied by how many times the lift wires (4) apply their tension between the spreader bars (20). A visual representation of this effect is demonstrated in FIG. 13a.

The Mechanical Advantage of a basic lacing system can be calculated as:

$$M A = ( 1 / 2 ) * ( {f}_{BLF} cos Θ + ( N - 1 ) )$$

where N represents the number of lacing steps in the system, and f_{BLF} is the Bottom Lacing Factor as mentioned previously. The term cos θ is applied where angle of the lifting wires (4) through a lacing step about a pulley is not 90°.

For a single lacing step process, such as in FIG. 19, the equation becomes

$$M A = ( 1 / 2 ) * ( {f}_{BLF} cos Θ )$$

The MA represents the maximum possible value of PFF which a tensioning mechanism (12) is possible of achieving if no frictional losses were present. In this analysis we have identified two forms of losses, the Lifting Point Efficiency (f_{LPE}) of lift wires running over lifting points, and the efficiency of the redirection of the lift wires, f₉₀, such as performed by pulleys. In previous equations such as (xix) it can be seen that the losses compound over multiple redirections of the lifting wires (4) about pulleys (19) and would complicate the ability to assess the total efficiency of the system as a single term, fₜₘ. Therefore, for demonstration purposes it is useful to consider an embodiment with a single lacing step, the total efficiency being defined as:

$${f}_{tm} = {f}_{LPE} * {f}_{90} ,$$

given that for a single step the lift wires (4) only have to complete one 90 degree turn.

Thus, the calculation for PFF for a single step tensioning mechanism becomes

$$P F F = M A * {f}_{tm} = ( 1 / 2 ) * {f}_{BLF} cos Θ * ( {f}_{LPB} * {f}_{90} ) .$$

which is comparable to the equation (xx) for a single step.

By way of example, the embodiment presented in FIG. 19b) is now considered using this equation for PFF. The Mechanical Advantage term is calculated as:

$$M A = ( 1 / 2 ) * ( {f}_{BLF} cos Θ ) = 0.5$$

Thus, to achieve a PFF of 0.4 using the embodiment of FIG. 19b, a pulley efficiency at least 80% may be required.

The f_{LPE} for the embodiment of FIG. 19b is one, as there are no frictional losses occurring from lift wires running over the lifting hooks 26, as in other embodiments. It will be appreciated that many ball bearing pulleys have an efficiency, f₉₀, of 90% or greater and thus the calculation for PFF for FIG. 19b is:

$$P F F = M A * {f}_{tm} = 0.5 * 0.9 = 0.45$$

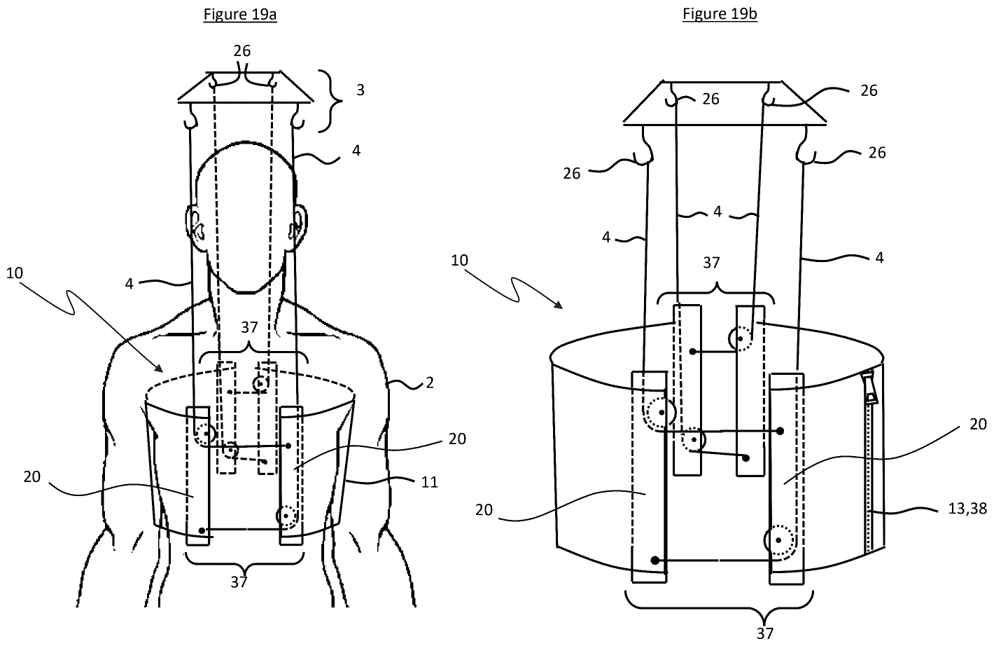

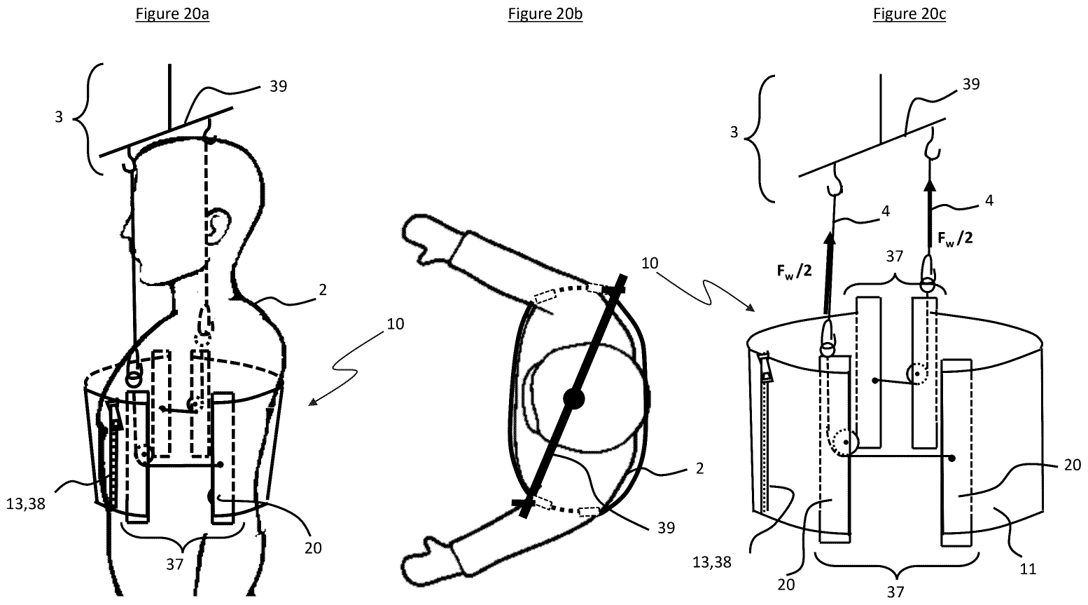

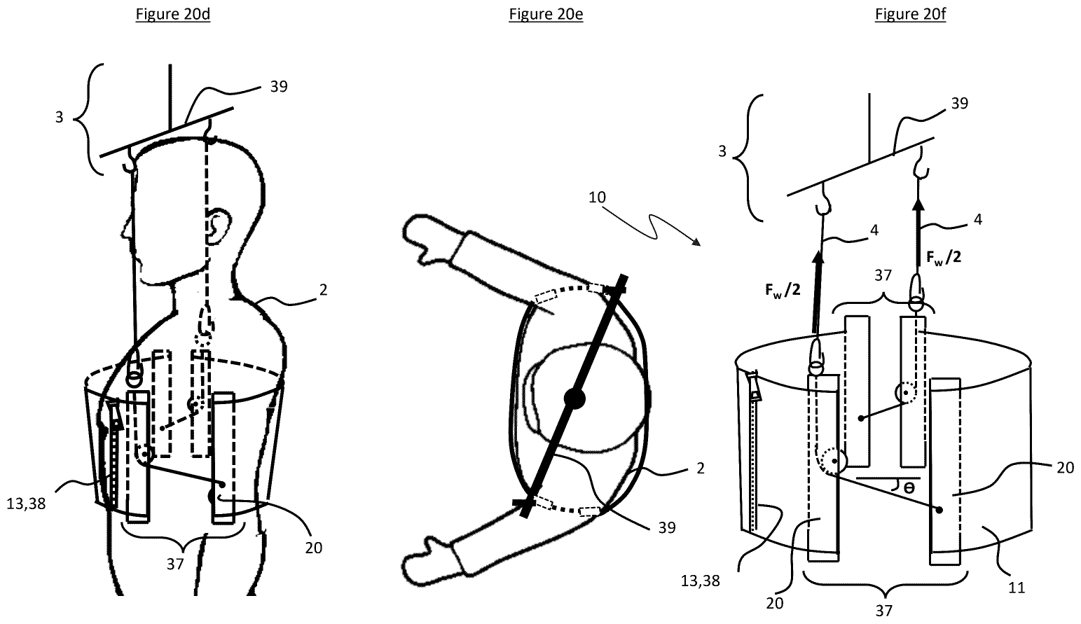

Thus, the embodiment of FIG. 19b should be able to lift a person solely through frictional contact of the harness (10) and patient's torso. FIGS. 20a)-c) show a further embodiment demonstrating the ability for the friction-lift torso harness (10) to successfully function using only two lift wires (4) in conjunction with a tensioning mechanism (12) incorporating two spreader sets (37) on opposing lateral sides of the patient (2).

To minimise the patient (2) experiencing feelings of discomfort or unease during patient handling, it is desirable to maintain the average vector of all lifting forces to be positioned directly above the centre of mas (CoM) of the patient (2). If the two individual lift wires (4) were both connected to the foremost, or rearmost spreader bar (20) of their respective spreader sets (37), the averaged lifting force vector would, respectively, be in front or behind the COM, thus tipping patient (2) backward or forwards accordingly during lifting.

This potential instability is counteracted by positioning the lift wires (4) connecting to the two spreader sets (37) to different spreader bars (20), i.e., one forward, one rearward. The two lift wires (4) are each directly attached to individual lift hooks (26) which are both mounted on a movable bridle (39). Thus, as the patient lift hoist (3) (including the aforesaid lift hooks (26) and bridle (39)) raises the patient (2) via the friction-lift torso harness (10), the CoM of the patient's weight supported by the friction lift torso harness (10) remains stably positioned under the averaged lifting force vector.

Considering the applicable PFF calculation for the embodiment shown in FIG. 20, as previously discussed, we can assume the use of ball-bearing pulleys (19) give 90% efficiency, and therefore, using the previously defined equation (xix) for k_{PFF}, i.e., k_{PFF}=T_{B}/F_{w}=(f_{LPE}/2)(f_{BLF} COS θ f₉₀¹), then

$${k}_{PFF} = ( 1 / 2 ) ( 1 cos ( 0 ) ( 0.9 ) ) = 0.45 \qquad ( xxxv )$$

i.e., greater than the PFF lift-threshold value of 0.4 and thus the embodiment is able to lift a patient (2).

It should be appreciated that FIG. 20a)-c) show the initial position (e.g., while the patient (2) is seated) of the two spreader sets (37) on opposing lateral sides of the patient (2) before any appreciable lift force has been applied. As the patient (2) is lifted, in each spreader set (37), the spreader bar mounting the single pulley (19) will be displaced upwards relative to the other spreader bar (20) of the spreader set (37), by an angle θ. Given the use of a rotatable pulley, it can be determined angle θθ=30°. Thus, given the previous analysis, it can be seen the mechanical advantage MA is given by:

$$M A = ( 1 / 2 ) * ( {f}_{BLF} cos Θ ) = 0.43$$

where BLF=1 and θ=30°.

The given MA result implies that to use a pulley with an efficiency, f₉₀, of less than of 93% will result in this embodiment using only a single pulley (19) per spreader set (37) without any means of preventing the vertical offset between the opposing halves of each spreader bar pair (20) will generate a PFF below the threshold of 0.4. Moreover, in practice a 93% efficient pulley is difficult to achieve, and therefore this embodiment does not present a suitable solution.

To expand the PFF calculation with a pulley of efficiency, f₉₀, 90% results in a

$$P F F = M A * {f}_{tm} = 0.43 * 0.9 < = 0.4$$

The analysis of the embodiments in FIG. 19 and FIG. 20 implies that an MA greater than 0.5 can achieve a potential PFF value of PFF>0.4.

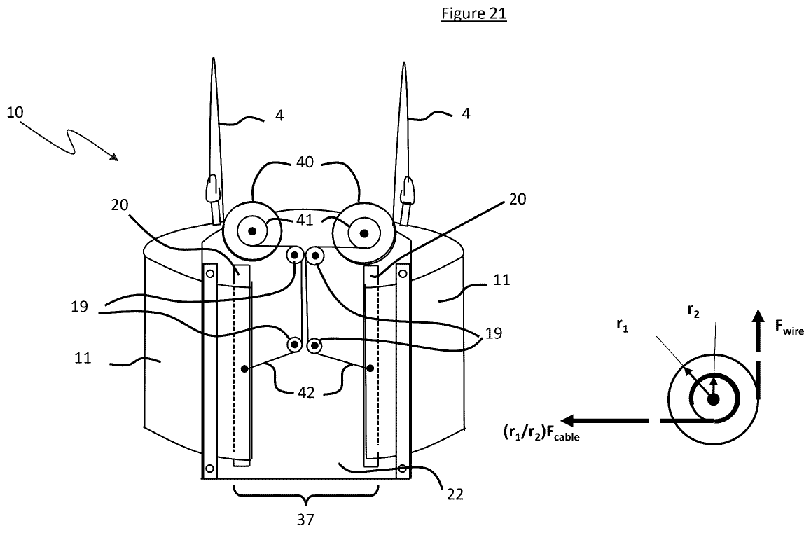

FIG. 21 shows an embodiment utilising an alternative configuration of tensioning mechanism (12) than the single radius pulleys (19) used in the preceding embodiments.

As previously discussed, pulleys are essentially one form of simple mechanical advantage mechanisms. Rotatable pulleys with bearings also provide low frictional loss relative to sheaves, rods, gears, and the like.

However, alternative mechanical advantage mechanisms, such as gearbox or lever mechanisms may also be utilised a tensioning mechanism (12) as an alternative to the pulley lacing-type systems to multiply the amount of force in the lift wire, F_{wire}, into tension (T_{B}) in the harness band (11).

In contrast to prior embodiments, where the lift wire (4) passes about multiple interlaced pulleys (19) to achieve the necessary force multiplication, the embodiment of FIG. 21 utilises co-axially mounted pulleys of different radii. The lift wire (4) passes about (and thus turns) a large outer pulley (40) with radius r₁, mounted to an axle on the back board (22). Co-axially mounted with the outer pulley (40) is a smaller inner pulley (41), radius r₂. A separate tensioning cable (42) is attached to the harness spreader bar (23) via small, intermediate pulleys (19). Thus, the lift wire (4) and tensioning cable (42) collectively form the tensioning strand of the tensioning mechanism.

This configuration employs the same principle as a gearbox or lever system, in that the tensioning cable (42) wrapped around the inner pulley (41) will have a greater tension than the lift wire (4) wrapped around the larger outer pulley (40), hence multiplying the force between the lift wire (4) and tensioning cable (42) proportional to the difference in pulley diameter r₁/r₂.

This configuration confers several benefits including:
The position where the lift wire (4) connects with the tightening mechanism (11) is effectively decoupled from the movement of the spreader bars (20) (in contrast to previous embodiments) as the lift wire (4) engages with the larger radius of the pulley (40) whose position is fixed during tightening.
the position where the tensioning cable (42) connects to the harness band (11) does not alter with respect to the travel of the spreader bars (20).
the co-axial pulleys (40, 41) are mounted independently of the spreader bars (20), so the net cross-section of spreader bars (20) can be reduced.
different types of wires/cables may be used for the lift wire (4) and tensioning cable (42), e.g., metal cables between the spreader bars (20) within the tensioning mechanism (12), and a polyester rope for the lift wire (4). It will be appreciated that high tensile materials such as metal wires, aramid cords and the like may be formed thin, with minimal diameters, while still retaining the requisite strength and wear resistance, whereas large diameter, soft, malleable polyester ropes offer more forgiving properties in case of any contact with the patient (2).
allowing both spreader bars (20) to be mutually non-parallel.
the force multiplication factor (i.e., the mechanical advantage) of lift wire (4) to harness band tension may be easily fine-tuned by alteration of the ratio r₁/r₂ of the pulleys (40, 41) radii. This offers more easily accessible iterations for customisation and optimisation, compared to the discrete steps of altering the number of pulley cross-lacing steps to alter force.
simple adjustment of the ratio of r₁ and r₂, by any increment.
swapping pulleys sizes for different patients, depending on factors such as their body type or clothing worn will allow a customised optimisation of the forces experienced by the patient during lifting.

Possible constraints of such configurations may include the comparatively larger size of the pulleys (40), and any associated discomfort this may cause a patient (2).

To calculate the PFF value for k_{PFF}, it is necessary to sum the moments about the axis of the coaxial pulleys (40, 41) to give:

$${F}_{wire} * {r}_{1} = {F}_{cable} * {r}_{2} . \qquad ( xxxvi )$$

Re-arranging for F_{cable} gives:

$${F}_{cable} = ( {r}_{1} / {r}_{2} ) * {F}_{wire} , \qquad ( xxxvii )$$

assuming 100% efficiency in the pulley bearings.

Thus, for example, if the larger radius r₁ is twice the size of the smaller radius r₂, then

$${F}_{cable} = ( 2 / 1 ) {F}_{wire} = 2 {F}_{wire .} \qquad ( xxxviii )$$

Given that the cable is routed directly to the spreader bar, and assuming equal distribution of the F_{w} between the lifting wires, such that F_{wire}=F_{w}/4

$${T}_{B} = {F}_{Cable} = 2 {F}_{wire} = 2 ( {F}_{w} / 4 ) = 0.5 {F}_{w .} \qquad ( xxxix )$$

Rearranging leads to,

$${k}_{PFF} = {F}_{B} / {F}_{W} = 0.5 \qquad ( xI )$$

This result gives a PFF value greater than the lift-threshold of 0.4 and would thus create a sufficient harness band (11) tension to lift a patient (2).

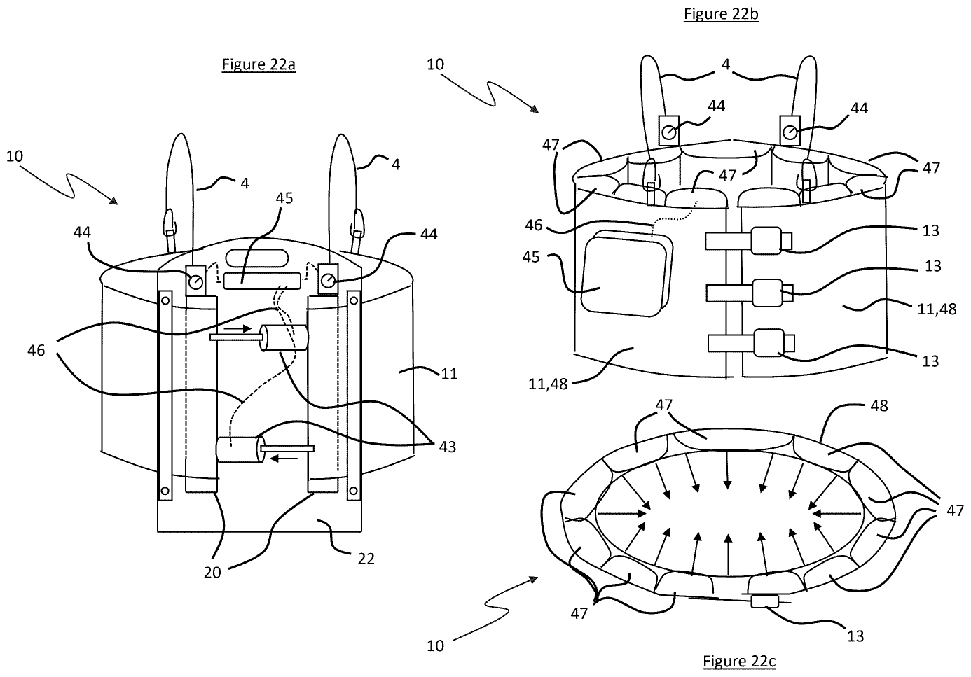

A tensioning mechanism (12) without pulleys (19) is also viable to achieve a compressive tension in a harness band (11) proportional to the contemporaneous weight being lifted. FIGS. 22a) and 22b) show two such alternative friction lift torso harness (10) embodiments for applying a compressive force normal to a patient's torso without using a pulley system.

The embodiment of FIG. 22a) utilises the same harness band (11), back board (22) and lift wires (4) attached to lift tabs (17) and extending over the shoulder of the patient (2) as the embodiments in at least FIGS. 1-3. However, instead of directly applying a closure force to the spreader bars (20) via the lift wires (4), this force is provided by a tensioning mechanism (12) in the form of one or more electronically controlled actuators (43), reversibly acting between the spreader bars (20).

The tension in the lift wires (4) is measured electronically by sensors (44) and the associated data generated is processed by control electronics (45) which output corresponding proportional control signals (46) to the actuators (43). The actuators (43) apply a closure force between the spreader bars proportional to the magnitude of the measured lift wire (4) tension. Beneficially, this tensioning mechanism (12) configuration allows the value of k_{PFF} value to be set electronically, thus potentially allowing a high degree of customisation and the ability to reliably set a value of k_{PFF}≥0.4. Naturally, this embodiment may require the existence and maintenance of control electronics and an associated electrical power supply (not shown).

FIGS. 22b) and c) also show an embodiment where sensors (44) measure the lift wire (4) tension and send that data to control electronics (45) to provide corresponding proportional control signals (46) to the tensioning mechanism (12). In contrast to the embodiment of FIG. 22a), the compressive force applied to the torso of the patient (2) is by a pneumatic air supply to inflatable bladders (47) inside a harness band (11) provided in the form of a rigid outer shell (48) that is hinged to allow fitting about the torso of the patient (2). The control electronics (45) output a control signal to the pneumatic air supply to apply a pressure to the inflatable bladders (47) proportional to the measured lift wire (4) tension, thus creating normal force against a patient's torso as shown in the medial torso view of FIG. 22c). Alternative layout configurations (not shown) of the inflatable bladders (47) are also possible, restricting the application of the compressive forces during lifting, solely to the portions of the torso circumference in contact with the inflatable bladders (47).

A benefit of this embodiment is a potential for the application of a circumferentially uniform and consistent force around all or designated portions of the patient's torso. Notable disadvantages include the additional complexity of a pneumatic and electronic controls comparative to a purely mechanical tensioning system, an increased difficulty in fitment to patients (2) and limited size adjustment capability.

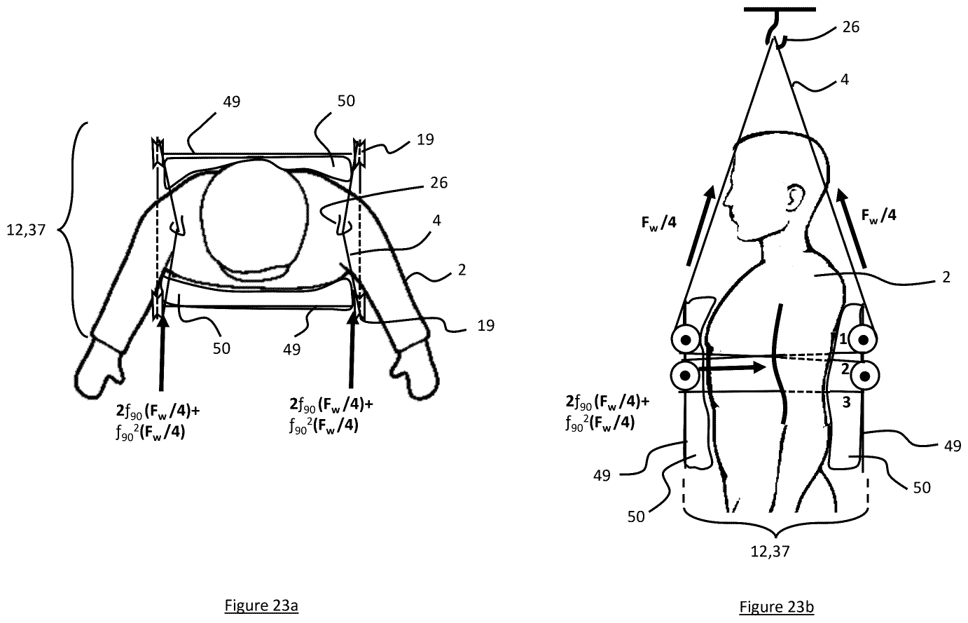

FIGS. 23a and 23b show a yet further embodiment incorporating a visually distinct friction-lift torso harness (10) from the preceding embodiments, which is still operationally and conceptually the same.

In contrast to the preceding embodiments, the harness band is implemented in the form of two substantially planar compression panels (49) oriented in use substantially vertically at on opposing sides of the patient's torso. In practice, disposing the panels (49) anteriorly and posteriorly will be the most ergonomic, comfortable and practicable configuration. The compression panels (49) need not necessarily form monolithic continuous solid surfaces, provided they possess sufficient structural integrity for their role and have provision for attachment of the tensioning mechanism and cushioning pads (50) on their respective torso-facing surfaces. The tensioning mechanism (12) connects the two compression panels (49) on opposing lateral sides.

Despite the visual dissimilarities, with embodiments such as shown in FIG. 9d), 19a)-b) and 20a)-c), the tensioning mechanism (12) is directly equivalent, formed as a pair of spreader sets (37), attached between the compression panels (49) on opposing lateral sides. In each spreader set (37) twin pairs of cross-laced pulleys (19) are attached to the compression panels (49), with a corresponding lift wire (4) acting therebetween. It can be seen that functionally, and when viewed transversely (as in FIG. 23b)), the two spreader bars (20) in each spreader set (37) are also lateral edges of the two compression panels (49). Tensioning the lift wires (4) during lifting acts to draw the two spreader bars (i.e., the compression panels (49)) together, thus applying compression to the torso of the patient (2). Note the compression panels (49) are also equivalent to, and play the functional role as, the harness band (11) in the preceding embodiments.

It can be thus seen that the harness band (11) of a tensioning mechanism (12) need not be a flexible band or the like, provided it is still able to apply a compressive force to the patient (2) under tension from the tensioning mechanism (12). The ‘sandwich board’ configuration of FIG. 23 also allows the majority of applied force to be restricted solely to the torso front and back which may be more comfortable for some patients (2).

As a consequence of the above-described functional similarity of this embodiment with the specified embodiment, a similar derivation may be employed to determine the PFF value, i.e., the required ratio of lifted force, F_{w}, to panel force, Fₚ. The following derivation determines the ratio between lifted force and force between the two panels (49), required to lift a person.

Beginning at the step for equating force of the lifted weight to the total friction force:

$${F}_{w} = {μ}_{eff} {F}_{N , tot ,} \qquad ( xIi )$$

for two panels pressing on the front and back of a person, and

$${F}_{N , tot} = 2 {F}_{panel ,} \qquad ( xIii )$$

where Fₚₐₙₑₗ is the force of one panel (49) pressing on the patient (2). Therefore,

$${F}_{w} = 2 {μ}_{eff} {F}_{panel .} \qquad ( xIiii )$$

We define the Proportional Forcing Factor (PFF) for panels, k_{W-P} which defines the relationship between lifted weight force, F_{w}, and the panel force, Fₚ, as

$${k}_{W - P} = {F}_{panel} / {F}_{w .} \qquad ( x1iv )$$

rearranging and substituting gives

$${F}_{w} = 2 {μ}_{eff} {k}_{W - P} {F}_{w .} \qquad ( x1v )$$

Cancelling like terms and rearranging for k_{W-P} presents an equation for determining the required proportion between weight force and panel force, k_{W-P} for a given coefficient of friction, μ_{eff}, i.e.;

$${k}_{W - P} = 1 / 2 {μ}_{eff} \qquad ( x1vi )$$

A PFF factor of greater than k_{PFF}≥0.4 may be required, for a given μ_{eff}, to ensure the weight being lifted does not slip. Thus, for instances where a value of μ_{eff}=0.45 has been applied, this gives a PFF value of;

$${k}_{W - P} > 1 / 2 μ = 1 / 0.9 = 1.1 \qquad ( x1vii )$$

The mechanism by which the lifted force is converted into panel force may have a value of k_{W-P}=1.1 or greater. In embodiments where tension in the harness band (11) is applied by a single tightening system (e.g., a single spreader set (37)), with a necessary value determined by k_{PFF} and that tension (or a proportion of it) acting on the whole harness band (11), the lacing forces are applied on both sides of the patient (2) and thus sum together to give the total compression panel (49) force. Thus, the force required by the spreader set (37) on just one side of the patient (2) is half of k_{W-P}=1.1, i.e., k_{W-P, oneside}=0.55

Analysing the spreader set (37) shown in FIG. 23b), we can determine k_{W-P, oneside}. The pulley (19) lacing pattern in FIG. 23b) shows the tension of a lift wire (4) acting 3 times on one side of a compression panel (49). Assuming that the pulleys (19) are 90% efficient, the total force acting on a side of the panel (49) is equal to:

$${F}_{panel} = 2 * ( {F}_{w} / 4 ) * 0.9 + ( {F}_{w} / 4 ) * {0.9}^{2} = 1.5 {F}_{w ,} \qquad ( x1viii )$$

rearranging to give k_{W-P},

$${F}_{panel} / {F}_{w} = {k}_{W - P , oneside} = 0.65 > 0.55 . \qquad ( xIix )$$

Therefore, the embodiment shown in FIG. 23 will create sufficient compressive force on the torso of a patient (2) to enable a successful lift.

Note that in comparing k_{W-P,oneside} to k_{PFF}, the ‘tension’ between the compression panels (49) is larger than the tension required in a more encircling harness band (11). Therefore, it suggests that distributing the compressive force over a greater portion of the torso may reduce the tension required and thus, possibly provide more comfort during use.

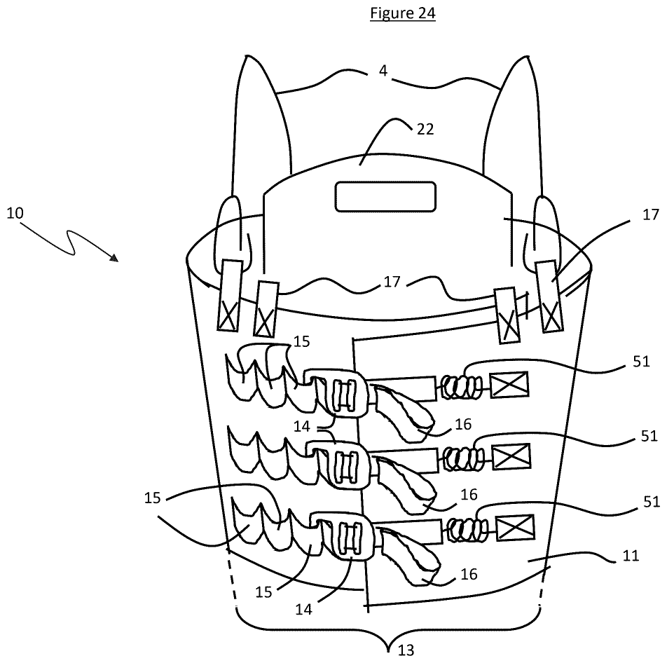

FIG. 24 shows a similar embodiment to that of FIG. 2, with the addition of a respiration relief mechanism in the form of springs (51), incorporated into the harness band fasteners (13). As will be apparent, the respiration relief mechanism need not necessarily be springs (51), nor form part of the harness band fasteners (13). Alternative forms of respiration relief mechanisms include portions of the harness band (11) being formed from elastic, or resilient materials, or including elastomeric materials in the fastening (13).

The harness band (11) of the friction-lift torso harness (10) will typically be made from very low stretch material. A low stretch material is desirable because the harness band (11) is subjected to the tensile force from the spreader bar (20), any appreciable stretching by the harness band (11) will increase its length. This additional length would need to be compensated for by additional travel of the spreader bars (20), requiring an additional length of lift wire (4) to be drawn from the tensioning mechanism (12), which is undesirable, as described previously. However, a negative consequence of a harness band (11) formed from such low-stretch material is that in use, when there is enough compressive force applied by the friction-lift torso harness (10) on the torso to lift a patient (2), any respiration by the patient (2) requiring an appreciable or perceptible expansion of the chest and abdomen will be constrained by the large compressive force from the tensioned friction-lift torso harness (10), potentially causing mild feelings of constriction.

The addition of springs (51) in the harness band (11) fastenings allows the circumference of the harness band (11) to increase under the pressure of the patient's (4) inhalation and associated increase of their ribcage and abdomen diameter. Springs are orientated in line with the applied tension in the harness band (11) and are thus subjected to the same tension. As the friction-lift torso harness (10) tightens, the springs (51) extend slightly under the applied tension. As the patient (2) is lifted, and the friction-lift torso harness (10) is subjected to the degree of tension necessary for lifting, the springs (51) will still be able to extend further. The spring constants of the springs (51) may be selected such that their reactionary force to any added extension due to respiration does not exceed that required by the patient (2) to comfortable expand their chest during inhalation.

The above-described respiration relief effect may also be achieved, not only by inclusion of an elastic section in the harness band (11), but alternatively by incorporation of a resilient or elastomeric padding, to line the inner surface of the harness band (11). Self-evidently, it is not desirable for all the harness band (11) material to be a slightly stretchable, as the friction-lift torso harness (10) is subject to high localised forces in areas such as the lift tabs (17).

Considered placement of the respiration relief means (such as springs (51) or elastic material panels (not shown) can aid in its physical minimisation and maximise its effect on patient (4) comfort. As an example, positioning elastic panels in front (i.e., anterior) portions of the harness band (11), where the tension is the lowest (as shown in FIG. 7c)-d)):
enables the use of smaller and/or lighter springs/elastic portions, and
maximises the effective lifespan of the spring/elastic portion due to being subjected to lower forces than in higher tension regions, such as adjacent the spreader bars (20).
optionally allows placement near the patient's axilla, as this region can experience the most discomfort during lifting.

Over time, though accumulated usage or after accidental soiling, the friction-lift torso harness (10) will require cleaning. As the primary patient contact component of the disclosed embodiment, the harness band (11) is most likely to require the most frequent cleaning, and this may be most effectively accomplished by use of a washing machine.

Pulleys (19), particularly ball-bearing pulleys (19) and possibly other components of the tensioning mechanism (12) are unsuited to cleaning in a washing machine. It is thus expeditious for nursing homes, hospitals, rehabilitation centres and so forth, to be able to easily remove the comparatively more expensive tensioning mechanism (12) from the friction-lift torso harness (10) to facilitate regular laundering of the harness band (11) in commercial or domestic washing machines. Similar considerations apply, albeit involving less volume, to domestic care environments utilising the disclosed embodiment.

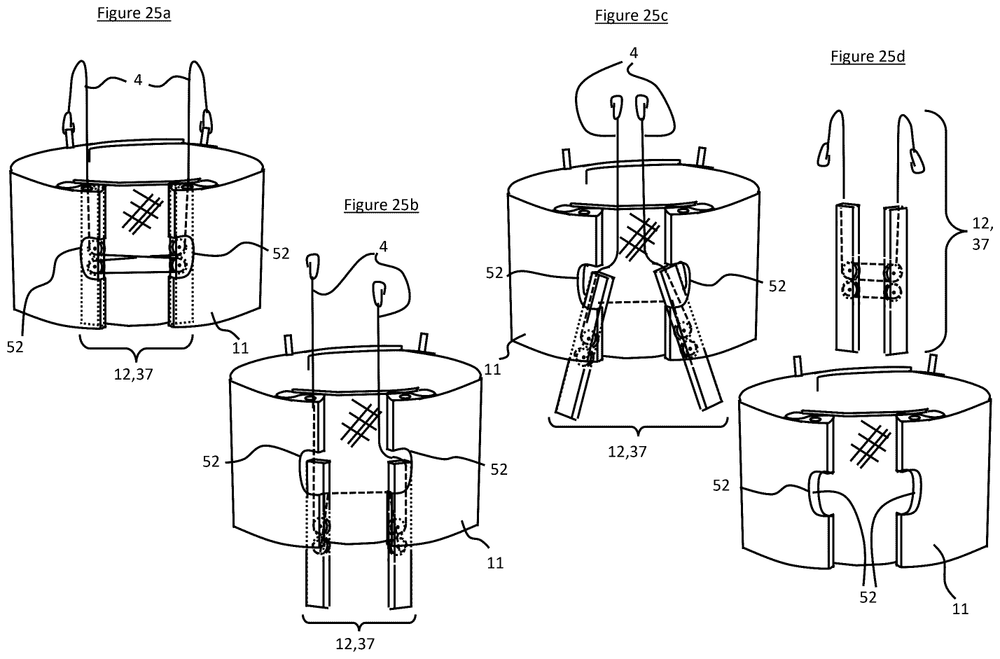

It will be appreciated that there are numerous means for attaching the tensioning mechanism (12) to the friction-lift torso harness (10) in a detachable configuration. Three different embodiments incorporating detachable tensioning mechanisms (12) are represented, in FIGS. 25, 26 and 27.

FIG. 25 shows a friction-lift torso harness (10) embodiment with a detachable tensioning mechanism (12), where individual FIGS. 25a) through to 25d) successively show stages of the detachment procedure, separating the tensioning mechanism (12), by manipulating a spreader set (37) and lift wires (4) from pockets (52) in the harness band (11). This method doesn't include a mechanical connection method such as a zip, thus simplifying the construction of the harness band (12) and improving potential reliability.

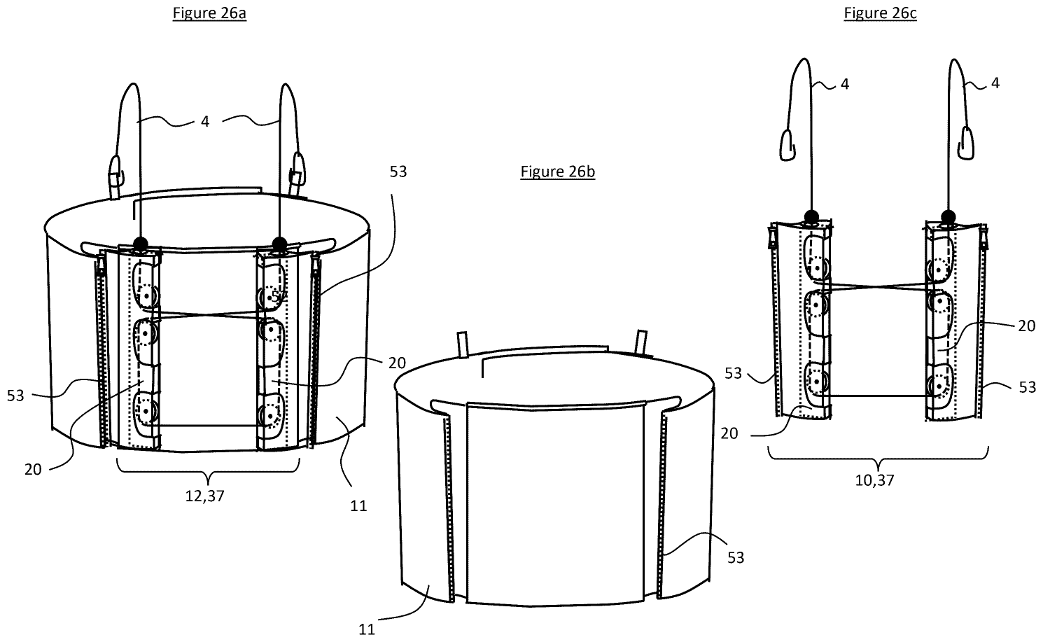

FIG. 26 shows an alternative embodiment with a tensioning mechanism (12) releasably attachable to the harness band (11) by a pair of zips (53), substantially adjacent, and parallel to the spreader bars (20) of the spreader set (37). Simply operating both zips (53) enables the tensioning mechanism (12) and harness band (11) (shown connected together in FIG. 25a)) to be easily detached by unzipping and separated (as shown in FIGS. 26b) and c).

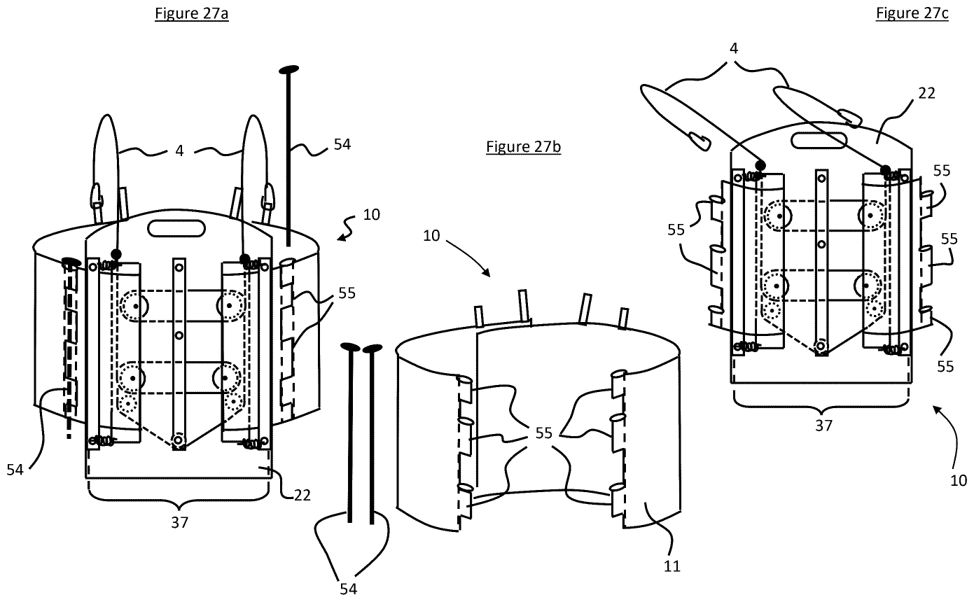

FIG. 27 shows a further alternative embodiment for a friction-lift torso harness (10) with a detachable tensioning mechanism (12). The configuration of the friction-lift torso harness (10) corresponds to that shown in the embodiments of FIGS. 2-4, with the addition of a pair of pin (54) and loop (55) connectors (54, 55) releasably connecting the tensioning mechanism (12) to the harness band (11).

The connectors (54, 55) are configured in a comparable arrangement to a typical door hinge, i.e., loops (55) are provided forming a series of interlocking portions sewn on, or attached to, both the tensioning mechanism (12) and harness band (11) adjacent the spreader set (37). An elongated pin (54) is passed through the aligned interlocking loops (55) to connect the tensioning mechanism (12) and harness band (11) together.

The pins (54) may be formed as a flattened plastic component, with sufficient strength and rigidity to withstand the harness band (11) tension, whilst also able to be contoured or sufficiently flexible to be comfortable when pressed against the patient's (2) body.

As previously referenced, there can be significant variation in the range of a patient's (2) physical form. The positioning of the lift wires (4) in the previously described embodiments is not obtrusive to most patients (2) during use of the patient moving device (1). It will be appreciated that some patients (2) of smaller stature, long hair, and/or otherwise uncomfortable with the proximity of the lift wires (4) to their head may be more comfortably accommodated by patient moving devices (1) embodiments with a greater horizontal separation of the lift wires (4) adjacent the patient's (2) head.

It will be readily appreciated that achieving a greater separation of the lifting wires (4) from the patient's (2) head may be accomplished by simply increasing the horizontal displacement between the corresponding lift hooks (26). It will also be appreciated however that a greater separation of the Lifting hooks (26) in embodiments such as shown in FIG. 13a would have the effect of applying an increased horizontal separating force on the uppermost pulleys (19) attached to the spreader bars (20), comparative to the lower mounted pulleys (19). The spreader bars (20) would thus experience an increased biasing force towards a V-shape configuration. Whilst it may be deemed the impact of such effects are not necessarily detrimental, it may be preferred to isolate the friction-lift torso harness (10) from such influences, whilst still using lifting hooks (26) with an increased horizontal separation.

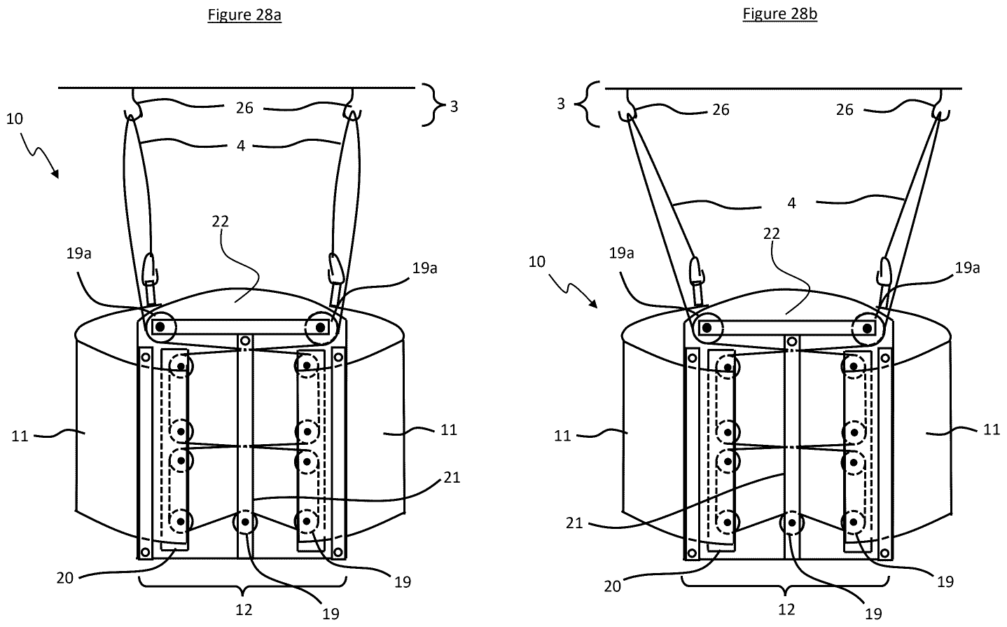

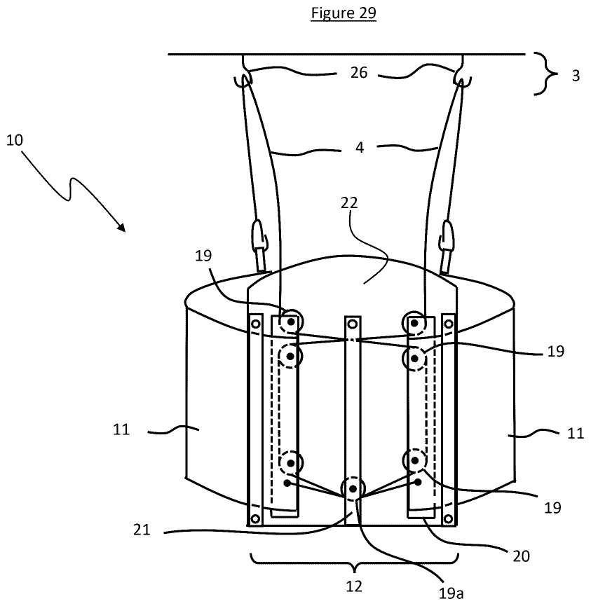

FIGS. 28a, 28b and FIG. 29 show further embodiments addressing this issue.

In more detail, FIG. 28a, shows a friction-lift torso harness (10) embodiment with lift wires (4) suspended beneath lift hooks (26) positioned with a substantially similar horizontal separation as the previously described embodiments. The substantial equivalence between separation of the lift hooks (26) and the horizontal separation of the upper-most pulleys (19) results in a substantially vertical orientation of the lift wires (4).

In comparison, FIG. 28b shows the same friction-lift torso harness (10) embodiment of FIG. 28a, used with lift hooks (26) with an increased horizontal separation. The mounting of the uppermost pulleys (19) to the back board (22) instead of the spreader bars (20) decouples the orientation of the spreader bars (20) from the effects of the lifting hook (26) positioning.

Each lifting wire (4) enters the tensioning mechanism (12) about a corresponding pulley (19a) mounted on the back board (22). These back board pulleys (19a) redirect the lifting wires (4) to the uppermost pulley (19) of the corresponding spreader bar (20). The embodiment of FIG. 28 ensures that the entry point of the lifting wires (4) is not dependent on the position of the spreader bars (20). Moreover, the angle of entry of the lifting wires (4) to the tensioning mechanism (12) has no effect on the force vectors of the tension strands (4) on the spreader bar (20), thus providing a consistent harness tightening performance regardless of the lifting hook (26) positions—which vary with the type of lifting hoist (3) used. It will also be understood by one skilled in the art, that alternative friction-lift torso harness (10) configurations are able to achieve the same effects, such as that shown in FIG. 29.

The friction-lift torso harness (10) shown in FIG. 29 differs from that of FIGS. 28a and 28b, by employing a centre pulley (19), bottom-mounted to the back board (22) via a centre spreader bar (21), with the tensioning cable (42) terminating at opposing attachments to the spreader bars (20).

It will be further recognised that in contrast to the mathematical analysis provided in previous embodiments, utilising substantially vertical lift wires (4), it is conceivable that practicable embodiments such as those of FIGS. 28 and 29 may use lift wires (4) subtending an angle (β) of up of approximately 20° from vertical.

The Mechanical Advantage of the FIG. 29 embodiment includes the calculation for a two-step lacing pattern in which θ is estimated at 20 degrees.

$$MA = ( 1 / 2 ) * ( {f}_{BLF} cos θ + ( N - 1 ) ) = ( 1 / 2 ) * ( 1 * cos ( 20 ) + 1 ) = 0.97$$

The PFF for such a two-step lacing pattern is calculated:

$$PFF = ( {f}_{LPE} / 2 ) ( {f}_{BLF} cos θ {{f}_{90}}^{2} + {f}_{90} ) = ( 0.8 / 2 ) * ( 1 * cos ( 20 ) * {0.9}^{2} + 0.9 ) = 0.66$$

Using Equation XXXX to compare PFF and MA allows us to calculate the necessary efficiency of the system as: fₜₘ=PFF/MA=0.66/1=0.66

The collective frictional losses in the system due to the lift wires (4) running over the lifting hooks (26) and the frictional losses in the ball bearing pulleys (19) thus has a total efficiency of 66%.

However, it can be easily understood from an exploration of the underpinning trigonometry on the effects of lift wire tension losses, that even a large β value of 20° would only generate a 6% tension loss. Given that the tension loss of a wire passing about a single pulley can easily exceed 30%, it can be seen such variances are relatively negligible in most embodiments and readily calculable if desired.

More broadly, it may be seen that numerous friction-lift torso harness (10) embodiments may be configured utilising different configurations and permutations of the above-described features, elements, mechanisms, pulleys, lacing arrangements and the like, including, but not limited to inclusion of:
back board;
spreader set;
spreader bar pair;
two Lift wires;
four Lift wires;
spreader bar coupling springs;
pulleys;
back board mounted pulleys;
low friction sheaves instead of pulleys;
gear mechanism;
compression panel pair;
removable tensioning mechanism;
respiration relief mechanism;
symmetric pulley tension cable lacing pattern;
asymmetric pulley tensioning cable lacing pattern;
singular tensioning wire runs between spreader bars in set at bottom (i.e. one wire per spreader set);
tensioning wires terminating on opposing spreader bar at bottom;
tensioning wires fasten to central point at bottom;
single lacing cross over between spreader bars in set;
multiple lacing crossovers between spreader bars in set;
lifting wires run parallel inside Spreader bars between pulleys or exit of spreader bar;
electric actuators;
force sensors;
hydraulic actuators;
levers/cam mechanism;
and any permutation or combination of same

It should be understood that there exist implementations of other variations and modifications of the present disclosure and its various aspects, as may be readily apparent to those of ordinary skill in the art, and that the disclosure is not limited by the specific embodiments described herein. Features and embodiments described above may be combined with and without each other. It is therefore contemplated to cover any and all modifications, variations, combinations or equivalents that fall within the scope of the basic underlying principals disclosed and claimed herein.

Changes and modification in the specifically described examples can be carried out without departing from the principles of the present disclosure which is intended to be limited only by the scope of the appended claims as interpreted according to the principles of patent law including the doctrine of equivalents.

1. A friction-lift torso harness for patient handling, the patient handling including raising and lowering a seated patient between a seated position and a raised activity position by lifting said friction-lift torso harness with a patient lift hoist, said friction-lift torso harness including:
a tensioning mechanism, including at least one tensioning strand; and
one or more torso-engagement sections coupled to said tensioning mechanism;
wherein, during at least part of the raising of a patient wearing said friction-lift torso harness, said friction-lift torso harness is configured to apply a compressive force to the patient's torso above the patient's hips, between at least two opposing exterior torso portions;
wherein the compressive force is applied with said tensioning mechanism via said one or more torso-engagement sections;
wherein said tensioning mechanism includes a pulley system with at least one rotatable pulley, said at least one tensioning strand passing about said at least one rotatable pulley; and
wherein the compressive force applied by said tensioning mechanism is proportional to the patient's weight being contemporaneously applied to the patient lift hoist.

2. A friction-lift torso harness as claimed in claim 1, wherein said tensioning mechanism includes at least one spreader set, wherein said spreader set includes a air of mutually opposed spreader bars, one of said spreader bars being reversibly movable towards, and away from, the other spreader bar of said pair.

3. (canceled)

4. A friction-lift torso harness as claimed in claim 2, wherein said pulley system includes said at least one rotatable pulley mounted on, or operatively connected to, at least one of said spreader bars.

5-8. (canceled)

9. A friction-lift torso harness as claimed in claim 1, wherein said one or more torso-engagement sections include a pair of torso-engagement sections that are formed as a harness band wherein said pair of torso-engagement sections are connectable together via a pair of separate connections, wherein said separate connections are provided by a releasable fastening and said tensioning mechanism, respectively.

10. (canceled)

11. A friction-lift torso harness as claimed in claim 9, wherein said torso harness is configured so that when said torso harness is fitted to the patient, said harness band and attached tensioning mechanism collectively at least partially encircle the patient's torso between the patient's 5^{th} and 10^{th} ribs.

12. A friction-lift torso harness as claimed in claim 9, wherein said tensioning mechanism is attached between separate portions of said pair of torso-engagement sections of said harness band.

13. (canceled)

14. A friction-lift torso harness as claimed in claim 9, including a spreader set with at least two spreader bars, at least one of said spreader bars being formed as:
an elongate bar, attached to a portion of the harness band, or
a rigid, semi-rigid, or stiffened portion of said harness band.

15-17. (canceled)

18. A friction-lift torso harness as claimed in claim 1, further including a bridge panel member.

19. A friction-lift torso harness as claimed in claim 18, wherein said bridge panel member is attached between separate portions of said one or more torso-engagement sections.

20. A friction-lift torso harness as claimed in claim 18, wherein said bridge panel member is attached to said tensioning mechanism.

21. A friction-lift torso harness as claimed in claim 18, wherein said pulley system includes at least one pulley mounted on, or operatively connected to, said bridge panel member.

22. A friction-lift torso harness as claimed in claim 1, wherein said at least one rotatable pulley is mounted on a:
harness band, at a first position,
first spreader bar, or
bridge panel member, and
operatively connected to one of said:
harness band, at a second position, or
a second spreader bar.

23-26. (canceled)

27. A friction-lift torso harness as claimed in claim 1, wherein for a given lifted patient weight force F_{w}, and tension T_{B} applied to said one or more torso-engagement sections, a Proportional Forcing Factor (PFF) is given by:
$${k}_{PFF} = \frac{{T}_{B}}{{F}_{w}}$$
and wherein the k_{PFF} of said friction-lift torso harness is at least 0.4.

28. (canceled)

29. A friction-lift torso harness as claimed in claim 27, wherein said Proportional Forcing Factor (PFF) is given by PFF=MA×fₜₘ, where MA is a mechanical advantage, and fₜₘ is a frictional efficiency of the friction-lift torso harness, and wherein:
MA is at least 0.5, and/or
fₜₘ is at least 50%.

30. A friction-lift torso harness as claimed in claim 27, wherein through an initial, substantially orthogonal, angular redirection of said at least one tensioning strand in said tensioning mechanism, the:
Mechanical Advantage (MA) is at least 0.5, and/or
frictional efficiency (fₜₘ) of said at least one tensioned tensioning strand is at least 50%.

31. A patient-moving device for patient handling, the patient handling including raising and lowering a seated patient between a seated position and a raised activity position, said device including:
a friction-lift torso harness as claimed in claim 1; and
a patient lift hoist, said at least one tensioning strand being operatively connected to said patient lift hoist;
wherein said friction-lift torso harness is configured so that for at least part of raising the patient, said friction-lift torso harness applies the compressive force to the patient that is proportional to the patient's weight being contemporaneously applied to said patient lift hoist via said at least one tensioning strand.

32. A patient-moving device as claimed in claim 31, further including at least one of: a terrain-engaging mobile chassis; and a chassis including at least one carriage, movably coupled to a track, mounted on an elevated structure.

33. (canceled)

34. A method of operating a patient-moving device as claimed in claim 31, said method including the steps of:
fitting the friction-lift torso harness to a sitting patient above the patient's hips and about the patient's exterior torso:
ensuring the at least one tensioning strand is operatively connected to the patient lift hoist; and
operating the patient lift hoist to apply tension to the at least one tensioning strand;
thereby applying a compressive force to the patient's torso between the at least two opposing exterior torso portions, the compressive force being proportional to the patient's weight being contemporaneously applied to the patient lift hoist via said at least one tensioning strand.

35. The method of claim 34, further comprising positioning the one or more torso-engagement sections about the exterior torso portions between the patient's 5th and 10th ribs.

36. The method of claim 34, wherein the one or more torso-engagement sections are positioned such that the compressive force is applied substantially orthogonally to the exterior torso portions.

37-41. (canceled)
